(19) United States
(12) Patent Application Publication
(10) Pub. No.: US 2019/0040878 A1
(43) Pub. Date: Feb. 7, 2019

(54) FOUR-WAY CONTROL VALVE FOR PNEUMATIC CHARGING AND DISCHARGING OF WORKING VESSEL

(71) Applicants: Ellen MELL, Farmington, MO (US); Dennis MELL, Farmington, MO (US); Michael GOLDFARB, Franklin, TN (US); Nexmatix LLC, St. Louis, MO (US)

(72) Inventors: Ellen Mell, Farmington, MO (US); Dennis Mell, Farmington, MO (US); Michael Goldfarb, Franklin, TN (US)

(73) Assignee: Nexmatic LLC, St. Louis, MO (US)

(21) Appl. No.: 16/071,685

(22) PCT Filed: Jan. 20, 2017
(86) PCT No.: PCT/US17/14337

§ 371 Date: Jul. 20, 2018

Related U.S. Application Data
(60) Provisional application No. 62/281,115, filed on Jan. 20, 2016.
(60) Provisional application No. 62/345,495, filed on Jun. 3, 2016.

(51) Int. Cl. F15B 11/064; F15B 13/04; F15B 1/26

(52) U.S. Cl. CPC F15B 11/064; F15B 13/0402; F15B 1/265; F15B 2013/0412; F15B 2211/21; F15B 2211/8855; F15B 2211/3057; F15B 2211/31582; F15B 2211/7052; F15B 2211/7053; F15B 2211/265

(57) ABSTRACT

A control valve comprises a body. A diverter is disposed within the body. The diverter is movably positionable within the body such that the diverter can assume a first position, second position and third position. The body includes one or more exhaust ports, a supply port, a first outlet port and a second outlet port. The body and diverter are configured such that: when the diverter is in the first position, the supply port and first outlet port fluidly communicate and the one or snore exhaust ports and second outlet port are fluidly isolated; when the diverter is in the second position, the first outlet port and one of the one or more exhaust ports fluidly communicate and the supply port and second outlet port are fluidly isolated; and When the diverter is in the third position, the first outlet port and second outlet port fluidly communicate and the supply port and the one or more exhaust ports are fluidly isolated.

### CROSS REFERENCE TO RELATED APPLICATION

This application claims the benefit of and incorporates by reference the entirety of PCT Application No. PCT/US17/14337 filed on Jan. 20, 2017; U.S. Provisional Patent Application No. 62/345,495 filed on Jun. 3, 2016 and U.S. Provisional Patent Application No. 62281115 filed on Jan. 20, 2016.

### STATEMENT REGARDING FEDERALLY SPONSORED RESEARCH OR DEVELOPMENT

Not applicable.

### SEQUENCE. LISTING, TABLE OR COMPUTER PROGRAM ON COMPACT DISC

Not applicable.

### FIELD OF INVENTION

This invention relates generally to control valves and particularly to pneumatic control valve, systems and methods.

### BACKGROUND OF THE INVENTION

Certain industrial applications require the charging and subsequent discharging of a working vessel with compressed gas, in a repeated cycle. For example, in blow molding applications, a part mold is filled with compressed gas during the molding process. After the part is formed, the compressed gas used to pressurize the mold is subsequently discharged from the mold. The process of charging (i.e., pressurizing) and subsequent discharging (i.e., depressurizing) of the mold with compressed gas is repeated for the next molded part. Another example of a process involving repeated charging and discharging of a working vessel is the actuation of the fluid chamber of a single-acting pneumatic cylinder. Single-acting pneumatic cylinders use the force of fluid (typically air) to move in one direction (either an extension or retraction stroke) and use a return force of another means (typically a spring) to move in the alternative direction. Alternately, a double-acting pneumatic cylinder uses the force of fluid (typically air) to move in both the extension and retraction strokes. The typical double-acting cylinder includes a piston housing (the cylinder) that encapsulates a piston that can slidably move within the housing along its length. The piston divides the piston housing into two chambers (a first and second chamber), the size of each chamber is variable and depends upon the location of the piston within the housing. Another example of a process involving repeated charging and discharging of a working vessel is the process of leak-checking a chamber. This chamber could, for example, be the internal volume of an engine, an automobile tire, a gasoline tank, or any other product that requires minimal leakage for proper function. To perform the leak-check, the chamber is filled with compressed gas and then, using industry standard procedures, a determination can be made as to the leak rate of compressed gas leaving said chamber. After determination of the leak rate, the compressed gas is subsequently discharged from the chamber. The process of charging (i.e., pressurizing) and subsequent discharging (i.e., depressurizing) of the chamber with compressed gas is then repeated fir the next part being tested.

The process of pressurizing and depressurizing (or charging and discharging) working vessel in applications such as are described above is typically controlled by a 2-position, 3-way, 3-port valve (hereafter called a 3-way valve). A typical 3-way valve is one that selectively connects three fluid ports in one of two respective port connectivity positions. A schematic diagram of the port connectivity provided by a standard 3-way valve 1 is shown in FIG. 1, where the labels P1 and P2 correspond to first and second valve positions, respectively. Although various arrangements of the three ports are possible, in keeping with a conventional usage, the three ports will be respectively referred to here as the supply (conventionally labeled in technical drawings with the letter “S”), exhaust (conventionally labeled in technical drawings with the letter “E”), and the outlet port (conventionally labeled in technical drawings with the letter “A”). Given this nomenclature, a standard 3-way valve can either be configured into a first position P1, which provides a port connectivity configuration in which outlet port A is connected to supply port S, and exhaust port E is isolated; or into a second position P2, which provides a port connectivity configuration in which outlet port A is connected to (in fluid communication with) exhaust port E, and supply port S is isolated (fluid flow between the supply port and all of the other ports of the valve is prevented). As shown in FIG. 2 supply port S is in fluid communication with pressure supply 5, which supplies a compressed fluid for the relevant industrial application. Exhaust port E is in fluid communication with (discharges to) an exhaust 6, which is typically atmosphere or exhaust piping or receptacle. In some cases, a valve may Maude a third position P3, which corresponds to a third port connectivity configuration, such as one in which all ports are isolated. In typical operation, however, only the first and second valve positions (i.e., port connectivity configurations) P1, P2 are used.

FIGS. 2 and 3 show a typical configuration in which a 3-way valve 1 is used to control the charging and discharging of a pressure vessel 3 via gas line 30. As shown in FIG. 2, when valve 1 is in a first position P1, outlet port A is connected to supply port S, and pressure vessel 3 is charged (Le., pressurized). As shown in FIG. 3, when valve 1 is in a second position P2, outlet port A is connected to exhaust port E, and the compressed gas in pressure vessel 3 is discharged through exhaust port E. Although valve 1 might be moved between positions P1 and P2 manually, in most automated applications, valve 1 is moved between the first and second positions P1, P2 via electrical actuation, such as via direct or pilot-actuated solenoid operation.

The control valve of the prior art suffers from the fact that it is not energy efficient and is not deployed in an energy efficient manner. In particular, during the course of a typical repeated charge and discharge cycle as illustrated in FIGS. 2 and 3, the entire mass of compressed gas contained within pressure vessel 3 is vented to atmosphere after each cycle. This discharge is inefficient and requires the provision of a new volume of compressed gas for each application. Rather than discard the entire mass of compressed gas during each discharge phase f the cycle, it would be desirable to reduce the consumption of compressed air by temporarily storing a portion of the compressed gas during the discharge process, and subsequently reusing a portion of the stored compressed gas during the following charging portion of the cycle.

### SUMMARY OF THE INVENTION

The present invention is directed to an improved control valve and systems and methods that reserve compressed gas for use in an application cycle. More specifically, this application describes embodiments of an energy-saving charge/discharge control valve, along with systems and methods, that control the repeated charging and discharging of a pressure vessel in a manner that enables the storage and subsequent reuse of compressed gas during the repeated charge and discharge cycle. In contrast to the control valve, systems and methods of the prior art, the present invention control valve and systems and methods do not discard the entire mass of compressed gas during each discharge phase of the cycle. An energy savings results from the recycling of compressed gas, which reduces the net consumption of compressed gas for a given charge/discharge cycle of a given pressure vessel.

In one aspect, the present invention is directed to a valve for controlling the flow of a fluid that re-uses compressed gas during the charging and discharging of pressure vessels. The valve comprises a valve body and a flow diverter disposed within the valve body. The flow diverter is movably positionable within the valve body such that the flow diverter can assume a first position, a second position and a third position. The valve body further comprises a plurality of external ports, the plurality of external ports comprising a supply poi% a first outlet port, a second outlet port and one or more exhaust ports. The flow diverter is actuated to assume one of the three noted positions to create or block fluid communication pathways among the external ports of the valve. Specifically, the valve body and flow diverter are configured, such that: a) when the flow diverter is in the first position, the supply port and the first outlet port are in fluid communication with each other and the one or more exhaust ports and second outlet port are each in fluid isolation; b) when the flow diverter is in the second position, the first outlet port and one of the one or more exhaust ports are in fluid communication with each other and the supply port and the second outlet port are each in fluid isolation; and c) when the flow diverter is in the third position, the first outlet port and the second outlet port are in fluid communication with each other and the supply port and the one or more exhaust ports are each in fluid isolation. The invention is also directed to a system and method that employs the present invention valve in various configurations.

The inventive valve may be embodied in various types of valve structures, but is preferably embodied in a cylindrical spool valve as is described more fully herein. In this respect, the present invention valve comprises a body having a first end and a second end. The preferred embodiment valve further comprises a spool (the flow diverter) within the body. The spool is slidably movable within the body and capable of being moved to a first spool position, a second spool position and a third spool position. As is discussed below, an important feature of the embodiment inventive valve is that the third spool (diverter) position is physically located between the first spool position and the second spool position. As with conventional valves, the body of the valve comprises one or more external ports. In the case of one embodiment of the inventive valve, the plurality of ports includes a first exhaust port, a supply port, a first outlet port, and a second outlet port. Hence, the inventive valve includes at least four external ports. In the preferred embodiment, the inventive valve comprises a second exhaust port

The spool and body of the embodiment valves described herein are configured such that the various external ports are in fluid communication with one or more other ports or in fluid isolation depending upon the positioning of the spool in the body. As used in this application, the terms “in fluid communication,” “fluidly connects” or “fluidly communicates” is used in reference to two or more ports or structures to describe the physical situation in which the valve permits fluid flow between those ports or structures. The terms “in fluid isolation” or “fluidly isolated” are used in reference to a port to describe the situation wherein the valve does not permit fluid flow between that port and any other port. However, and as explained below, in the case where the valve has more than one exhaust port, when the exhaust ports are collectively referred to as being fluidly isolated, that means the exhaust ports are isolated from the valve's other ports, but may be fluidly connected to each other.

In the case of the four-port embodiment of the present invention valve, the valve regulates fluid communication and isolation among the ports as follows. When the spool is in the first position, the supply port and the first outlet port are in fluid communication with each other and the exhaust port and second outlet port are each in fluid isolation. When the spool is in the second position, the first outlet port and the exhaust port are in fluid communication with each other and the supply port and the second outlet port are each in fluid isolation. When the spool is in the third position, the first outlet port and the second outlet port are in fluid communication with each other and the supply port and the exhaust port are each in fluid isolation. Additional embodiments of the inventive valve and systems incorporating those embodiments are described herein and are not intended to be limiting

The present invention control valve allows for the storage and reuse of compressed gas with a minimal amount of additional apparatus, and with minimal requirement for system reconfiguration, relative to a conventional implementation. As is discussed below, the recycling of compressed gas is enabled by a unique combination of 4-way port connectivity configurations provided by the present invention valve. Implementation of the valve in an energy-saving system requires only 1) replacement of a standard 3-way control valve with a present invention energy-saving control valve and 2) addition of a pressure reservoir to temporarily store the compressed gas between the charge and discharge cycles. As such, a minimum amount of apparatus is required to implement the recycling of compressed gas—the only additional component needed being a pressure reservoir. The present invention control valve thus reduces the consumption of compressed air by permitting the temporary storing of a portion of the compressed gas during the discharge process. The valve can then be actuated to reuse a portion of the stored compressed gas during the following charging portion of the cycle.

### BRIEF DESCRIPTION OF THE DRAWINGS

FIG. 1 is a schematic diagram of port connectivity for a standard 2-position, 3-way, 3-port valve.

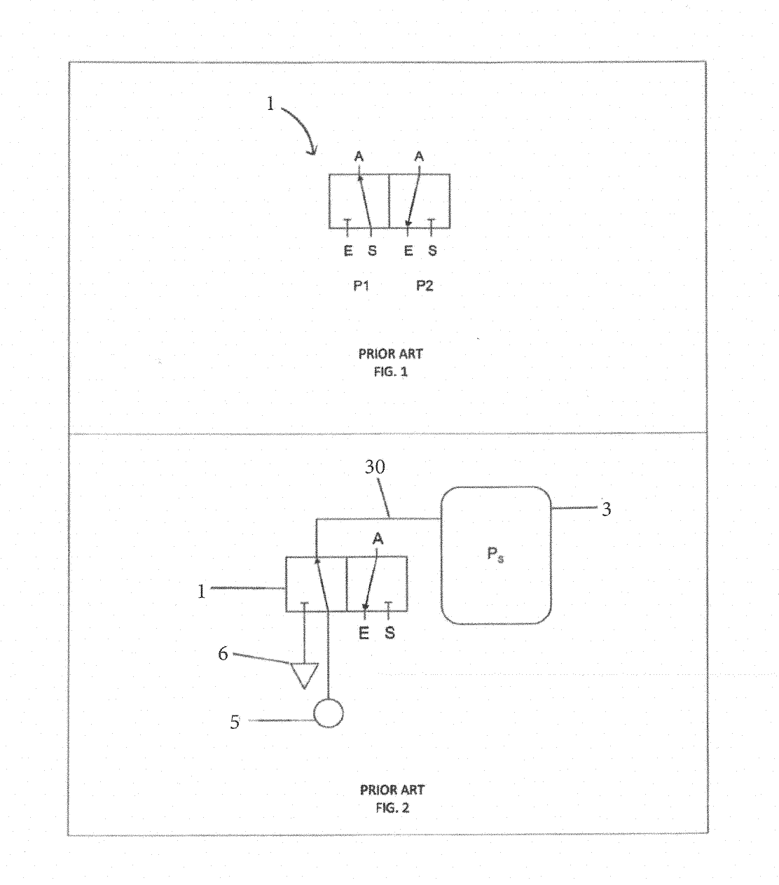

FIG. 2 is a schematic diagram of a standard configuration for a working vessel charging via a standard 3-way control valve, the diagram showing the control valve in the first position.

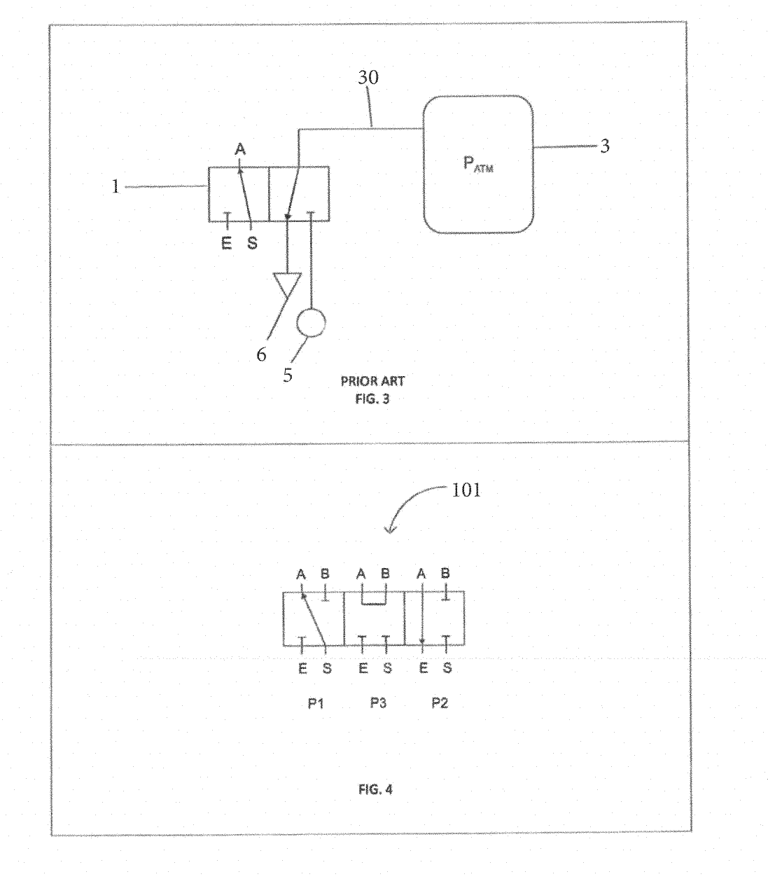

FIG. 3 is a schematic diagram showing a standard configuration for a working vessel discharging via a standard 3-way control valve, the diagram, shoving the control valve in the second position.

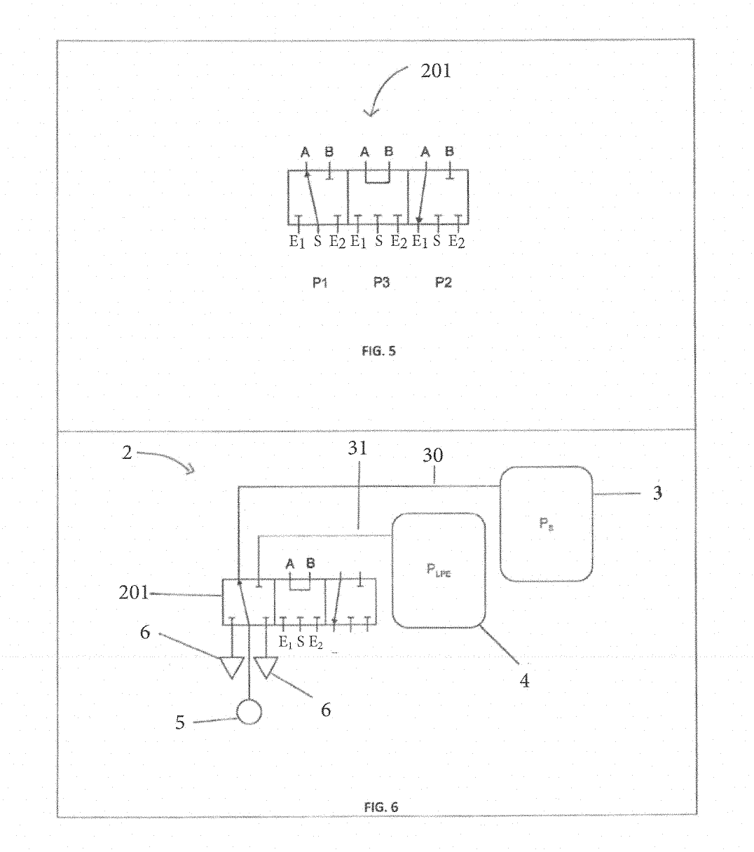

FIG. 4 is a schematic diagram depicting port connectivity for a 4-port embodiment of a present invention valve.

FIG. 5 is a schematic diagram depicting port connectivity for a 5-port embodiment of a present invention valve.

FIG. 6 illustrates an embodiment application of a 5-port embodiment of the present invention valve and is a schematic diagram showing a circuit of a pneumatic system that employs an embodiment 5-port directional control valve according to the present invention. The embodiment valve is shown in the first position, which results in charging of the pressure vessel.

FIG. 7 is a schematic diagram depicting the embodiment application circuit of FIG. 6. The embodiment valve is shown in the third position for transitioning from the first (charge) to the second (discharge) positions. The third position enables the first step in the discharging process by equilibrating pressure between the pressure vessel and reservoir (i.e., temporarily storing compressed gas from the pressure vessel in the reservoir). This state is the high-pressure equilibrium state, also called the first equilibrium state.

FIG. 8 is a schematic diagram depicting the embodiment application circuit of FIG. 6. The embodiment valve is shown in the second position, which discharges the remaining compressed gas from the pressure vessel.

FIG. 9 is a schematic diagram depicting the embodiment application circuit of FIG. 6. The embodiment valve is shown in the third position for transitioning from the second (discharge) to the first (charge) positions, which serves as the first step in the charging process by equilibrating pressure between the pressure vessel and reservoir (i.e., recycling compressed gas from the reservoir to the pressure vessel). This state is the low-pressure equilibrium state, also called the second equilibrium state.

FIG. 10 is a schematic diagram showing a standard configuration for pressurization of a spring-return, single-acting cylinder with a standard 3.-way control valve, the control valve being in the first position. The spring-return, single-acting cylinder returns to the extended position when depressurized and the retracted position when pressurized.

FIG. 11 is a schematic diagram showing a standard configuration for exhaust (i.e., depressurization) of a single-acting cylinder with a standard 3-way control valve, the control valve being in the second position.

FIG. 12 illustrates an alternate embodiment application of a 5-port embodiment of the present invention valve and is a schematic diagram showing a pneumatic circuit system that employs an embodiment directional control valve according to the present invention in connection with a single-acting cylinder. The embodiment valve is shown in the first position. Setting of the valve in the first position results in pressurization of the cylinder. This pressurization, in turn, results in retraction of the piston rod.

FIG. 13 is a schematic diagram depicting the embodiment application circuit of FIG. 12. The embodiment valve is shown in the third position when transitioning between piston rod retraction and extension. This position corresponds to the high-pressure equilibrium state, also called the first equilibrium state.

FIG. 14 is a schematic diagram depicting the embodiment application circuit of FIG. 12. The embodiment valve is shown in the second position. Setting of the valve in the second position results in the discharge of the remaining compressed gas from the cylinder and completes extension of the piston rod.

FIG. 15 is a schematic diagram depicting the embodiment application circuit of FIG. 12. The embodiment valve is shown in the third position when transitioning between piston rod extension and retraction. This position corresponds to the low-pressure equilibrium state, also called the second equilibrium state. Assuming load conditions such that P(LPE) is high enough to overcome the force of the spring in the cylinder, the actuator will be configured into the first actuator position (retracted) in this state. Pressurization of the cylinder is completed by subsequently switching back to the first position of the valve, as shown in FIG. 12.

FIG. 16 is a diagrammatic view of the flow-determining cross section of the body and spool configuration for a 3-position; 5-port spool valve constructed in accordance with the present invention.

FIG. 17 is a diagrammatic view of the flow-determining cross section of the spool and body configuration for a 3-position, 5-port spool valve constricted in accordance the present invention, the valve having body-mounted sealing elements.

FIG. 18 is a diagrammatic view of the flow-determining cross section of the spool and body configuration for a 3-position, 5-port spool valve constructed in accordance with the present invention, the valve having spool-mounted sealing elements.

FIG. 19 is a schematic diagram of an embodiment application circuit that includes a two-solenoid, 5-port embodiment of a present invention valve depicted in a diagrammatic, flow-determining cross section view. The embodiment valve is shown in the first position, which position results when the first solenoid is energized and the second solenoid is de-energized.

FIG. 20 is a schematic diagram depicting the embodiment application circuit of FIG. 19 along with the two-solenoid, 5-port embodiment valve depicted in a diagrammatic, flow-determining cross section view. The embodiment valve is shown in the second position, which position results when the first solenoid is de-energized and the second solenoid is energized.

FIG. 21 is a schematic diagram depicting the embodiment application circuit of FIG. 19 along with the two-solenoid, 5-port embodiment valve depicted in a diagrammatic, flow-determining cross section view. The embodiment valve is shown in the third position, which position results when the first and second solenoids are de-energized.

FIG. 22 is a schematic diagram of an embodiment application circuit that includes a three-solenoid embodiment of a present invention valve depicted in a diagrammatic, flow-determining cross section view. The embodiment valve is shown in the first position, which position results when the first and third solenoids a energized and the second solenoid is de-energized.

FIG. 23 is a schematic diagram depicting the embodiment application circuit of FIG. 22 along with the embodiment three-solenoid embodiment valve depicted in a diagrammatic, flow-determining cross section view. The embodiment valve is shown in the second position, which position results when the second and third solenoids are energized and the first solenoid is de-energized,

FIG. 24 is a schematic diagram depicting the embodiment application circuit of FIG. 22 along with the embodiment three-solenoid embodiment valve depicted in a diagrammatic, flow-determining cross section view. The embodiment valve is shown in the third position, which position results when the third solenoid is energized and the first and second solenoids are de-energized.

FIG. 25 is a schematic diagram depicting the embodiment application circuit of FIG. 22 along with the embodiment three-solenoid embodiment valve depicted in a diagrammatic, flow-determining cross section view. The embodiment valve is shown in the de-energized configuration (all solenoids de-energized), which results ire fluid communication among the first outlet port, the second outlet port and exhaust.

FIG. 26 is a schematic diagram depicting the embodiment application circuit of FIG. 22 along with the embodiment three-solenoid embodiment valve depicted in a diagrammatic, flow-determining cross section view. The embodiment valve is shown in the first manual override configuration, which moves the spool into the first position, and provides fluid communication exclusively between the supply port S and first outlet port A.

FIG. 27 is a schematic diagram depicting the embodiment application circuit of FIG. 22 along with the embodiment three-solenoid embodiment valve depicted in a diagrammatic, flow-determining cross section view. The embodiment valve is shown in the second manual override configuration, which moves the spool into the second position, and provides fluid communication exclusively between the exhaust port E₁ and first outlet port A.

FIGS. 28-35 illustrate an alternate embodiment application of the present invention valve and are schematic diagrams showing a pneumatic circuit system that employs two embodiment 5-port directional control valves according to the present invention in connection with a double-acting cylinder. The figures show the configuration of the valves as the system goes through the method states in which the chambers of the double-acting cylinder are charged and discharged,

FIG. 36 depicts a section view of an embodiment 5-port valve according to the present invention with the spool shown in the first spool position.

FIG. 37 depicts a section view of an embodiment 5-port valve according to the present invention with the spool shown in the second spool position.

FIG. 38 depicts a section view, of a three solenoid embodiment 5-port valve according to the present invention with the spool shown in the third spool position

### DETAILED DESCRIPTION

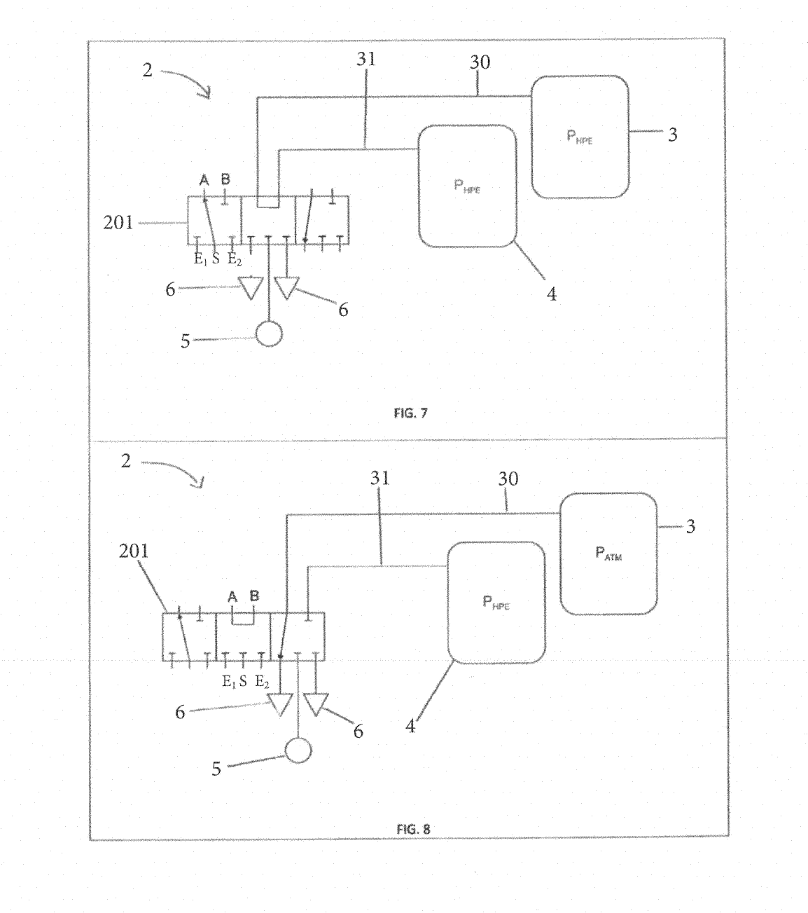

The inventive valve will now be described in the context of its preferred embodiment spool valve configuration. In a first preferred embodiment, the present invention valve includes a supply port S, first outlet port A and second outlet port B and one or more exhaust ports E. A schematic diagram of the port connectivity provided by a 4-port embodiment of the present invention valve 101 is shown in FIG. 4.

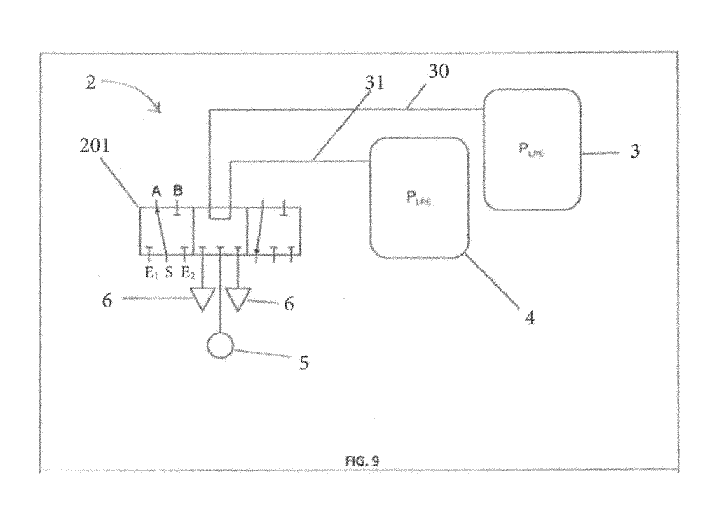

Although the valve 101 need only have four distinct fluid ports, in certain embodiments the function of the exhaust port E may be achieved by two physical ports, a first exhaust port E₁ and a second exhaust port E₂, both of which are characterized by the same (typically atmospheric) fluid potential. A schematic of the port connectivity provided by a 5-port embodiment valve 201 is shown in FIG. 5.

Note that in FIG. 5 one of the exhaust ports E₁, E₂ in the preferred 5-port embodiment valve 201 is not used. Despite this, the 5-port embodiment valve 201 is a preferred embodiment because a 5-port configuration is a standard, preferred configuration in the pneumatic industry, and as such, a 5-port embodiment of the valve maintains a standard connectivity with existing pneumatic apparatus (e.g., valve manifolds). As such, illustrations of the valve embodiment and functionality herein are provided in the context of the 5-port embodiment valve 201. It should be clear to one having ordinary skill in the art that a 4-port embodiment, such as valve 101, is merely a simplification of the 5-port version, because elimination of the fifth port (which is the second exhaust port) yields a 4-port embodiment of the inventive valve. For conciseness the inventions are explained herein in terms of a 5-port embodiment valve.

As shown in FIG. 5, the inventive energy-saving control valve selectively connects the four distinct fluid potentials in one of three respective connectivity configurations. In the first, valve position, the first outlet port A is in fluid communication with the supply port 5, while the second outlet port B and the one or more exhaust ports E₁, E₂ maintained in fluid isolation. In the second valve position, the first outlet port A is in fluid communication with the first exhaust port E₁, while the second outlet port B, the supply port S and second exhaust port E₂ are each separately maintained in fluid isolation. The third valve position, which is positioned between the first and second valve positions, is characterized by the first outlet port A and the second outlet port B being in fluid communication, and the supply port S and the one or more exhaust ports E₁, E₂ being fluidly isolated. Note that unless otherwise stated, in the case where the valve is equipped with more than one exhaust port, the exhaust ports need not be isolated from each other—only from the supply port S and the outlet ports A and B. This is what is meant by the phrases “isolation of the one or more exhaust ports” or “the one or more exhaust ports are in fluid isolation,”

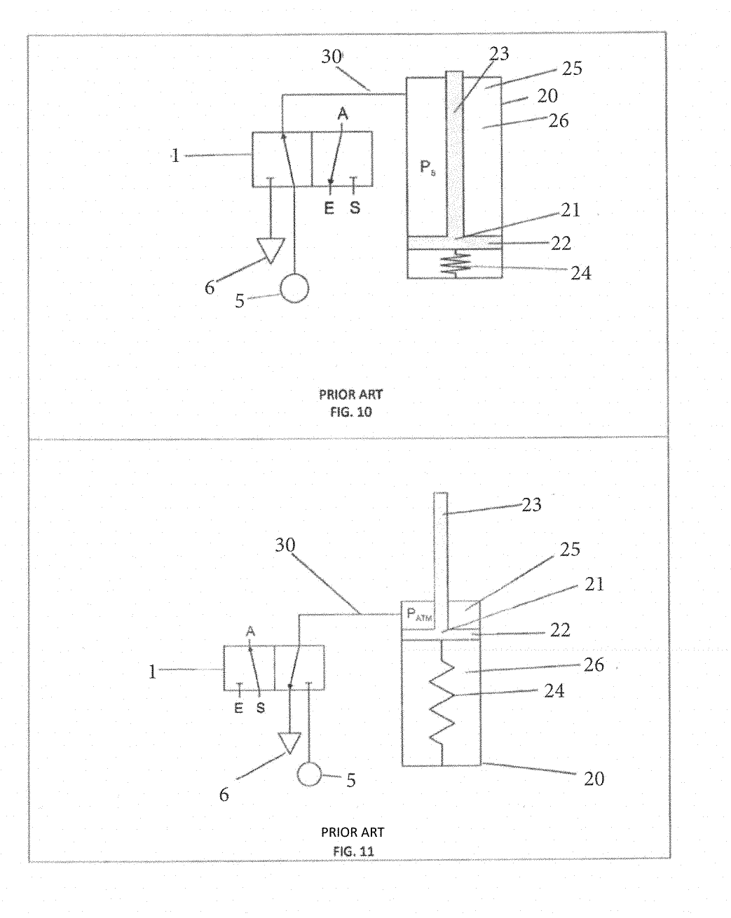

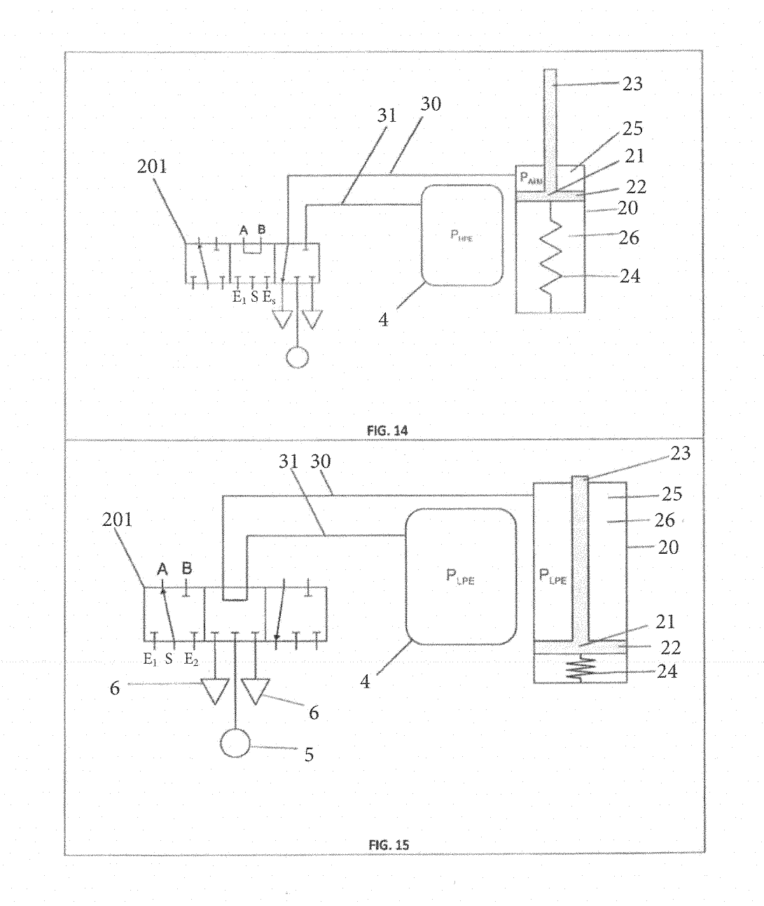

FIGS. 6 through 9 illustrate an exemplary circuit 2 configuration system employing a valve 201 according to the present invention for the repeated charge and discharge of a working vessel (pressure vessel) 3 (effectively a fluid chamber). As is the case with the typical charge/discharge control system, the process of charging and discharging working vessel 3 is singularly controlled by control valve 201, although the system 2 is additionally supplemented with a reservoir 4. Gas line 30 provides a fluid pathway in and out of vessel 3 to valve 201. Gas line 31 provides a fluid pathway in and out of reservoir 4 to valve 201. Further, the features discussed herein apply equally to any type of working vessels. Thus, the embodiment inventive system of FIGS. 6-9 includes valve 201 fluidly connected to fluid supply 5, reservoir 4 and working vessel 3.

Consider first the case in which working vessel 3 is in a charged state, which results from configuring valve 201 into the first valve position P1. In the first position P1, valve 201 provides the same connectivity between the first outlet port A and the supply port S as does a conventional 3-way control valve in the first position. Hence, first outlet port A is connected to supply port 5, resulting in charging (i.e., pressurization) of pressure vessel 3, as illustrated in FIG. 6. In addition to the connectivity between first outlet port A and supply port S, the valve also isolates all other ports (i.e., the one or more exhaust ports E₁, E₂ and second outlet port B).

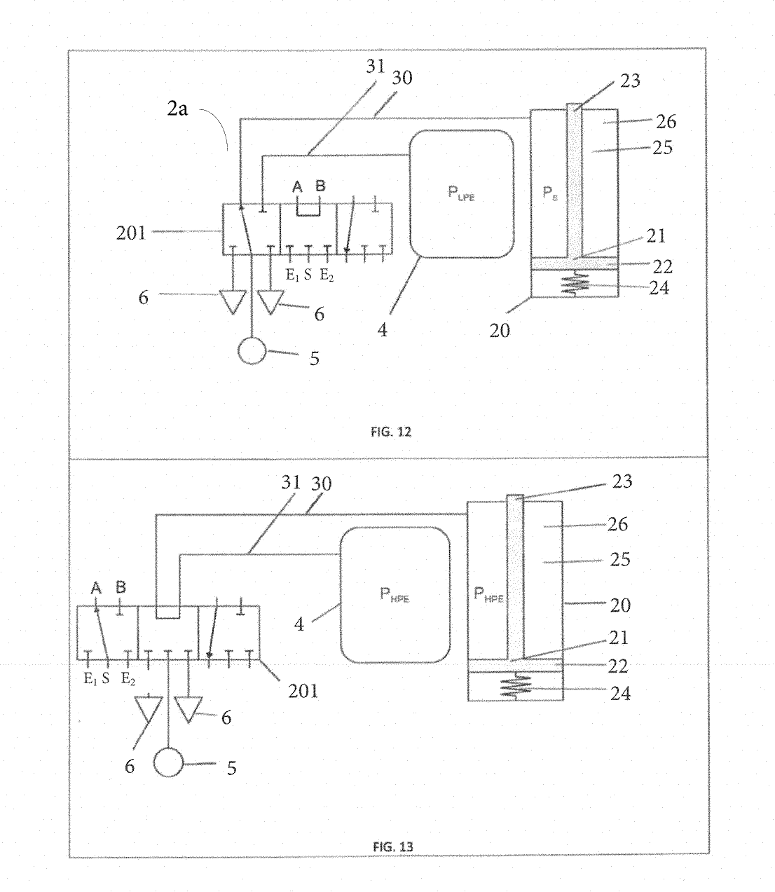

The third position P3 of valve 201 introduces two additional states to the charge/discharge cycle, relative to a standard 3-way control valve. Specifically, rather than immediately connect first outlet port A to one of the one or more exhaust ports (exhaust ports E₁, E₂), the discharge process in valve 201 is initiated by temporarily switching control valve 201 into the third position, P3, which, as shown in FIG. 7, connects first outlet port A and second outlet port B, While isolating supply port S and the one or more exhaust ports E₁, E₂. The port connectivity created by third position P3 provides a configuration in which the pressures in the chambers of vessel 3 and reservoir 4 will arrive at a common equilibrium pressure (given sufficient time). Vessel 3 is initially at the supply pressure, while the pressure in reservoir 4 is initially at an intermediate value, referred to here as the low-pressure equilibrium pressure. Because the low-pressure equilibrium pressure will be lower than the supply pressure, and given the constitutive behavior of compressed gas, equilibration of the chamber pressures of vessel 3 and reservoir 4 will require a portion of the compressed gas in chamber 3 to flow into reservoir 4.

In the case where the volumes of vessel 3 and reservoir 4 are equal, for example, the two chambers of vessel 3 and reservoir 4 will reach an equilibrium in which the mass of compressed gas in both will be equal. This (first) equilibrium state is referred to as the high-pressure equilibrium state, and the equilibrium pressure in both vessel 3 and reservoir 4 referred to as the high-pressure equilibrium pressure. Following a sufficient period of time, referred to here as the first dwell time, in which system 2 is in the first equilibrium state, the discharge process is completed by moving valve 201 into the second position P2. This is shown in Figure

In the second position P2, valve 201 provides the same connectivity between first outlet port A and an exhaust port (either E₁ or E₂) as does a conventional 3-way valve in the second position. In the second position P2, first outlet port A is connected to exhaust port E₁, and the remaining mass of compressed gas in the pressure vessel 3 is discharged to atmosphere (i.e., the vessel is depressurized). In addition to the connectivity between first outlet port A and exhaust port E₁, valve 201 in this position also isolates all other ports (i.e., second outlet port B, supply port S, and remaining exhaust port E₂). Note that, because second outlet port B is isolated while valve 201 is in second position P2, the pressure in reservoir 4 will remain at the high-pressure equilibrium pressure until the following equilibrium state.

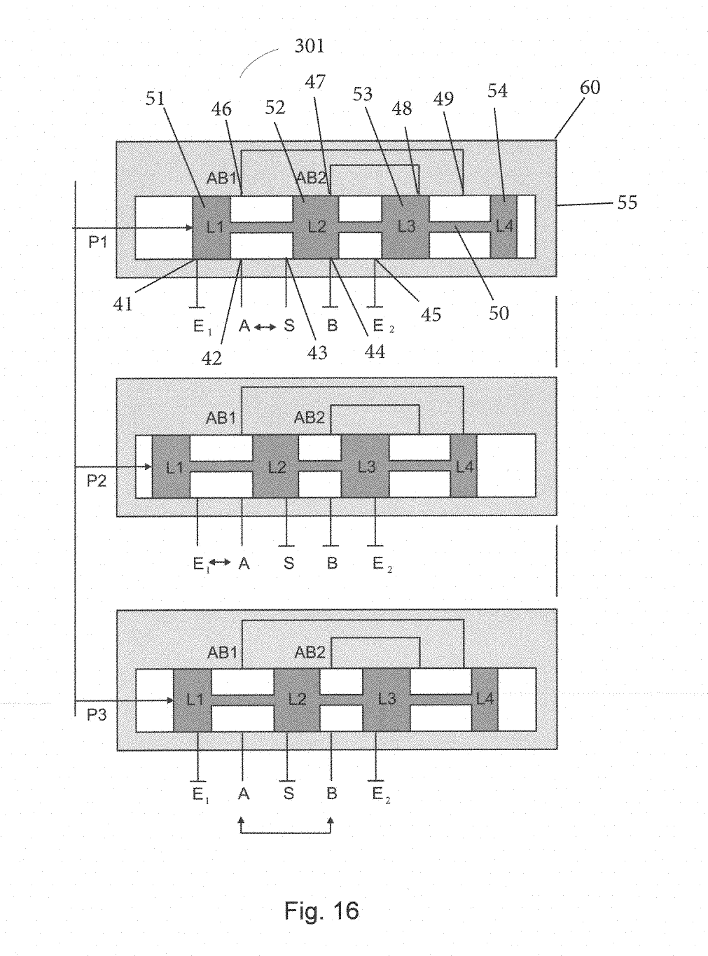

In order to initiate the charge portion of the charge/discharge cycle, rather than immediately connect first outlet port A to the supply port S, the charge process is initiated by temporarily switching control valve 201 back to third position P3. This is shown in FIG. 9. Temporarily switching valve 201 back to third position P3 connects first outlet port A with second outlet port B, while isolating supply port S and the one or more exhaust ports E₁, E₂. This port connectivity enables an equilibration of the pressures in vessels 3 and reservoir 4. Because the pressure in reservoir 4 is initially at the high-pressure equilibrium pressure, and the pressure in vessel 3 is initially at atmosphere, a portion of the compressed gas in reservoir 4 will flow to vessel 3. In the case where the volume of both chambers of vessel 3 and reservoir 4 are equal, for example, the two chambers will reach an equilibrium in which the mass of compressed gas in both will be equal. This (second) equilibrium state is referred to as, the low-pressure equilibrium state, and the equilibrium pressure in both chambers of vessel 3 and reservoir 4 referred to as the low-pressure equilibrium pressure. Following a sufficient period of time (referred to here as the second dwell time) in which system 2 is in the second equilibrium state, the charging process is completed by moving valve 201 back to first position P1. This is shown in FIG. 6. Moving valve 201 to first position P1 results in vessel 3 being fully charged. The charge/discharge cycle can then be repeated. Note that, because second outlet port B is isolated while valve 201 is in first position P1, the pressure in reservoir 4 will remain at the low-pressure equilibrium pressure until the following equilibrium state.

The process of compressed gas saving can be modeled as follows. Assuming ideal gas constitutive behavior, isothermal processes, and constant-volume chambers, one can show that the high-pressure equilibrium pressure is given by:

$${P}_{HPE} ( k ) = ( \frac{1}{1 + {V}_{R}} ) ( {P}_{S} + {V}_{R} {P}_{LPE} ( k - 1 ) ) \qquad ( 1 )$$

where V_{R} is the volume ratio between the reservoir 4 and pressure vessel 3, given by:

$${V}_{R} = \frac{{V}_{B}}{{V}_{A}} \qquad ( 2 )$$

where V_{A} and V_{B} are the volumes of pressure vessel 3 and reservoir 4, respectively, k denotes the charge/discharge cycle (where k=1 is the first cycle), P_{HPE}(k) is the high-pressure equilibrium pressure at the current charge/discharge cycle, P_{LPE}(k−1) is the low-pressure equilibrium pressure during the previous change/discharge cycle, and P_{S} is the supply pressure, Given similar assumptions, the low-pressure equilibrium pressure at the current cycle is given by:

$${P}_{LPE} ( k ) = ( \frac{1}{1 + {V}_{R}} ) ( {P}_{ATM} + {V}_{R} {P}_{HPE} ( k ) ) \qquad ( 3 )$$

where P_{LPE}(k) is the low-pressure equilibrium pressure at the current charge/discharge cycle k, P_{HPE}(k) is the high-pressure equilibrium pressure at the current cycle given by (I), and P_{ATM} is atmospheric pressure. Equations (1) and (3) can be combined to yield a single recursive equation for the low-pressure equilibrium pressure:

$${P}_{LPE} ( k ) = ( \frac{1}{1 + {V}_{R}} ) ( {P}_{ATM} + {V}_{R} ( \frac{1}{1 + {V}_{R}} ) ( {P}_{S} + {V}_{R} {P}_{LPE} ( k - 1 ) ) ) \qquad ( 4 )$$

This equation is a first-order difference equation of the form:

$$\begin{matrix}{P}_{LPE} ( k ) = {aP}_{LPE} ( k - 1 ) + b \\ where & ( 5 ) \\ a = {( \frac{{V}_{R}}{1 + {V}_{R}} )}^{2} \\ and & ( 6 ) \\ b = ( \frac{1}{1 + {V}_{R}} ) \tilde{P} \\ where & ( 7 ) \\ \tilde{P} = ( {P}_{ATM} + ( \frac{{V}_{R}}{1 + {V}_{R}} ) {P}_{S} ) & ( 8 )\end{matrix}$$

The solution for the first-order difference equation (5) is given by:

$${P}_{LPE} ( k ) = {a}^{k} {P}_{LPE} ( 0 ) + \frac{b ( {a}^{k} - 1 )}{a - 1} \qquad ( 9 )$$

Assuming reservoir 4 is hilly depressurized at the start of the charge/discharge process, the initial pressure, P_{LPE}(0) in (9) is P_{ATM}. Equation (9) is stable if and only if a<1, which based on equation (6), will always be true. As such, the difference equation (9) will converge at a sufficient number of cycles to a steady-state equilibrium pressure given by:

$${\overline{P}}_{LPE} = \frac{b}{1 - a} \qquad ( 10 )$$

Substituting equations (6-8) into equation (11) yields a low-pressure equilibrium pressure in the steady state of:

$${\overline{P}}_{LPE} = ( \frac{1 + {V}_{R}}{1 + 2 {V}_{R}} ) \tilde{P} \qquad ( 11 )$$

Combining equations (9) and (10), one can show that the number of cycles required to obtain a fraction γ of the steady state pressure, assuming the initial pressure in the reservoir is P_{ATM}, is given by:

$$k = ( \frac{ln ( ( 1 - γ ) b ) - ln ( ( a - 1 ) {P}_{ATM} + b )}{ln a} ) \qquad ( 12 )$$

Assuming, for example, a reservoir 4 of equal volume to the pressure vessel 3 (i.e., V_{R}=1), one can show from equation (12) that the low-pressure equilibrium pressure will reach 95% of its steady-state value (i.e., γ=0.95) after three cycles. Assuming the system reaches the steady-state low-pressure equilibrium pressure given by equation (12), and continuing the assumptions of ideal gas behavior and an isothermal process, the ratio of mass recycled during each cycle to total charge mass can be written as:

$$\frac{{m}_{r}}{{m}_{A}} = \frac{{\overline{P}}_{LPE}}{{P}_{S}} \qquad ( 13 )$$

where mᵣ is the mass of compressed gas recycled from the previous cycle and m_{A} is the total mass of compressed gas required to charge pressure vessel 3. The amount of mass required to charge pressure vessel 3 without recycling is given by:

$${m}_{A} = \frac{( {P}_{S} - {P}_{ATM} ) {V}_{A}}{RT} \qquad ( 14 )$$

where RT is the product of the ideal gas constant and the nominal gas temperature (Le., a constant under the assumed isothermal conditions). The amount of mass required to charge vessel 3 with recycling is given by:

$${m}_{AR} = \frac{( {P}_{S} - {\overline{P}}_{LPE} ) {V}_{A}}{RT} \qquad ( 15 )$$

As such, the amount of compressed gas required for each charge cycle relative to the amount without recycling is given by

$$p = \frac{{m}_{AR}}{{m}_{A}} = \frac{{P}_{S} - {\overline{P}}_{LPE}}{{P}_{S} - {P}_{ATM}} \qquad ( 16 )$$

and therefore the compressed gas savings relative to a standard system is given by:

η=1−p (17)

Assuming, for example, reservoir 4 is of equal volume to pressure vessel 3 (i.e., V_{R}=1), atmospheric pressure of 0.1 MPa (1 bar), and a supply pressure of 0.6 MPa (6 bars), the steady-state low-pressure equilibrium pressure would be:

$${\overline{P}}_{LPE} = ( \frac{2}{3} ) ( {P}_{ATM} + ( \frac{1}{2} ) {P}_{S} ) = ( \frac{2}{3} ) ( \frac{1}{6} + \frac{1}{2} ) {P}_{S} = {( \frac{2}{3} )}^{2} {P}_{S} \qquad ( 18 )$$

such that the compressed gas savings would be p=⅔ and the savings relative to a standard process given by η=⅓ (33% savings). in the limit that reservoir 4 becomes much larger than pressure vessel 3, assuming the same ratio of atmospheric to supply pressure (1:6), the steady-state low-pressure equilibrium pressure will approach:

$${\overline{P}}_{LPE} \approx ( \frac{1}{2} ) ( {P}_{ATM} + {P}_{S} ) = ( \frac{1}{2} ) ( \frac{1}{6} + 1 ) {P}_{S} = ( \frac{7}{12} ) {P}_{S} \qquad ( 19 )$$

such that the compressed gas savings will approach p≈½, and the savings relative to a standard process will similarly approach η=½ (50% savings). In the case that o pressure reservoir 4 is used (i.e., V_{R}=0), the steady-state equilibrium pressure will be P̅_{LPE}=P_{ATM}, the relative mass requirement p=1, and the relative savings η=0 (i.e., no savings possible without a pressure reservoir).

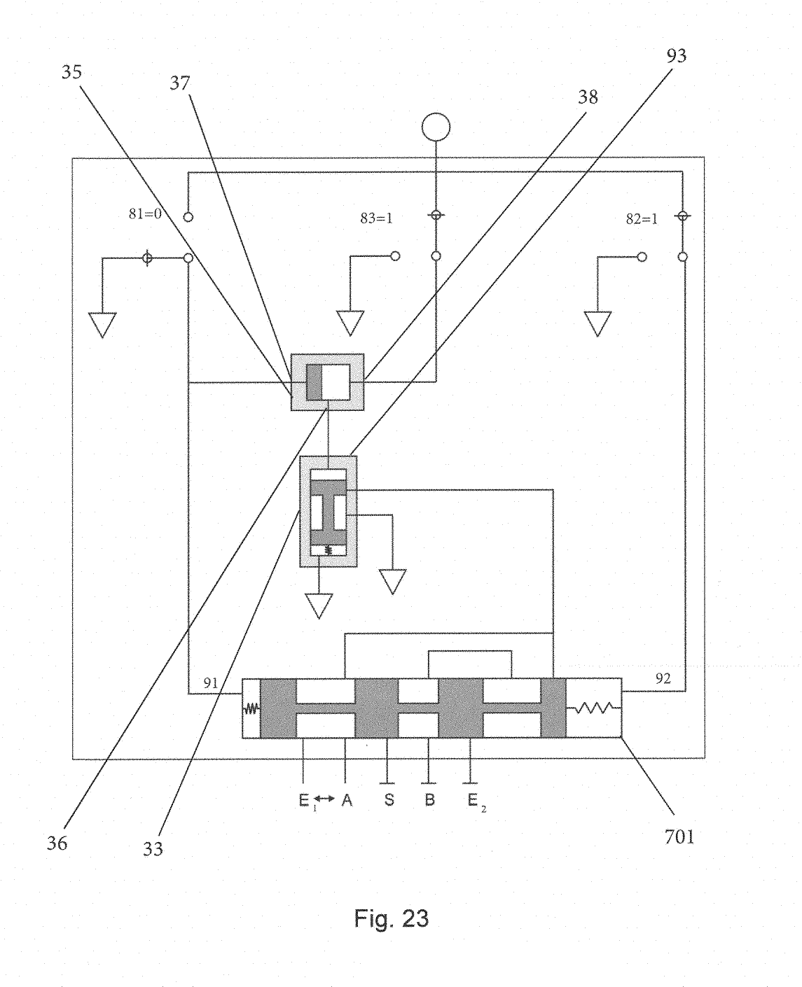

As previously mentioned, a 5-port embodiment valve provides compatibility with a 5-Port valve manifold interface (i.e., the porting footprint on which the valve is mounted), and therefore is a preferred embodiment of the present invention valve. The port connectivity required for a 5-port valve according to the present invention can be realized in a 3-position spool-type valve 301 as shown in the flow-determining schematic diagram in FIG. 16. In embodiment valve 301 schematically shown, valve 301 includes valve spool 50 that slides linearly within valve body 60. Valve body 60 interfaces with a given apparatus (i.e., manifold) via five external ports, which are typically associated with four distinct fluid potentials, referred to here as the supply port S, exhaust ports E₁, E₂, first outlet port A and second outlet port B. As shown in the figure, valve exhaust is provided via two physically distinct ports E₁, E₂. In addition to external ports, the valve body 60 contains a series of internal ports 41-45 located within valve body 60, which correspond to each of the five external ports, in addition to four additional internal ports 46-49 associated with opposite ends of two respective internal flow paths (channels) AB1 and AB2.

In one preferred embodiment, valve spool 50 employs four spool lobes 51-54, which are the first, second, third, and fourth spool lobes, respectively. As valve spool 50 slides to each respective position within body 60, internal ports 41-45 and 46-49 within body 60 are selectively isolated or exposed via lobes 51-54 on valve spool 50, which results in a prescribed port (i.e., fluidic) connectivity between the external ports. In a preferred embodiment, spool 50 is axisymmetric and has a circular cross-section, which facilitates positive fluidic sealing between body 60 and spool lobes 51-54. Three-position valve 301 is described by three distinct port connectivity configurations, which are referred to as the first, second, and third valve positions (P1, P2, P3), respectively (see schematic in FIG. 5), which corresponds to the three positions of spool 50 within valve body 60. Although not shown in FIG. 16, valve spool 50 is typically moved between these positions via electrical actuation, such as via direct or pilot-actuated solenoid actuation. As shown in FIG. 16, when valve spool 50 is in first position P1, in which spool 50 is positioned furthest to the right in the figure, first outlet port A and supply port S are maintained in a state of fluid communication between the first lobe 51 and second lobe 52 of spool 50, while first lobe 51 isolates first exhaust port E₁, second lobe 52 isolates second outlet port B, and third spool lobe 53 isolates the internal flow channel AB2 from the second exhaust port E₂ and internal flow channel AB1. The resulting external port connectivity provides fluid communication between first outlet port A and supply port 5, and fluid isolation of both exhaust ports E₁, E₂ and second outlet port B.

When valve spool 50 slides to the second position P2, in which the spool position is furthest to the left in FIG. 16, first outlet port A and first exhaust port E₁ are maintained in a state of fluid communication between the first lobe 51 and second lobe 52, while second lobe 52 isolates supply port S; second outlet port B is isolated between second lobe 52 and third lobe 53; second exhaust port E₂ is isolated by third lobe 53; and the AB1 port 49 is isolated by fourth spool lobe 54. The resulting external port connectivity provides fluid communication between first outlet port A and first exhaust port E₁, and fluid isolation of the supply port S and second outlet port B. In other words, the second exhaust port E₂ is fluidly isolated from all other ports and the second outlet port B is similarly fluidly isolated from all other external ports.

As seen in FIG. 16, when valve spool 50 is in third position P3, which is the center position of the spool, first outlet port A is maintained in a state of fluid communication with the first internal flow channel AB1 between first lobe 51 and second lobe 52; second outlet port B is maintained in a state of fluid communication with second internal flow channel. AB2 between second lobe 52 and third lobe 53; and first internal flow channel AB1 is maintained in a state of fluid communication with second internal flow channel AB2 between third lobe 53 and fourth lobe 54. As such, first outlet port A is maintained in a state of fluid communication With the second outlet port B. Further, first exhaust port E₁ is maintained in fluid isolation by first spool lobe 51; supply port S is isolated by the second spool lobe 52; and second exhaust port E₂ by third lobe 53. The resulting external port connectivity provides exclusive fluid communication between the first outlet port A and second outlet port B, and fluid isolation of supply port S and exhaust ports E₁, E₂.

Note that configuring the third spool position physically between the first and second spool positions, as enabled by the embodiment described here, enables effective ordering of port connectivity as per the previously described two-stage charge and discharge functionality. If either the first or second position were located in the center position of the valve, valve 301 would be required to move through the supply or exhaust condition, respectively, prior to the equilibration position, which in either case would decrease the efficacy of the compressed gas recycling, because the spool cannot move infinitely quickly through a given port connectivity configuration. As such, an important aspect of the preferred embodiment is one in which the third spool position is located physically between the first and second.

Note that the second exhaust port E₂ (furthest to the right) in the preferred embodiment of the valve 301 shown in FIG. 16 is not used in any of the valve positions. As such, second exhaust port E₂ could be eliminated completely without otherwise affecting valve functionality. Thus, another preferred embodiment of the valve is one that is configured as shown in FIG. 16, but without second exhaust port E₂, such that the valve is in effect a 4-port rather than a 5-port valve. AS previously mentioned, however, valve 301 is depicted in FIG. 16 in the context of 5 external ports, because the typical manifold (not shown) upon which the valve is mounted commonly have a footprint consistent with the 5 external ports shown, and because conversion from a 5-port to 4-port embodiment is straightforward.

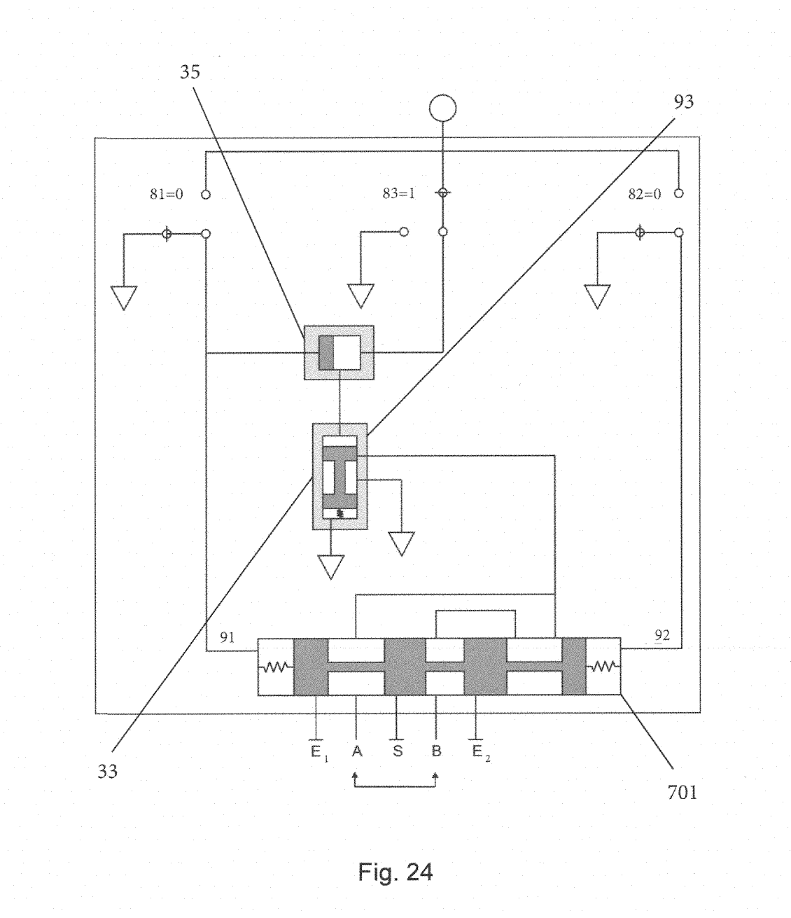

FIG. 17 is an enhanced flow-determining schematic diagram that shows a preferred embodiment of the 5-port valve 401 in which sealing elements 70 are affixed to valve body 60 in order to seal the spaces between radially-projecting perimeter surfaces 58 of spool lobes 51-54 and valve body 60 and thus facilitate fluid isolation. Specifically, each sealing element 70 precludes fluid flow across the boundary established by a perimeter surface 58 of a spool lobe 51-54 and the respective sealing element 70. The configuration of spool geometry and body sealing elements shown in FIG. 17 for valve 401 provides the same 3-position port connectivity that characterizes the embodiment valves 201, 301 and its connectivity is described above and shown in FIGS. 5 and 16.

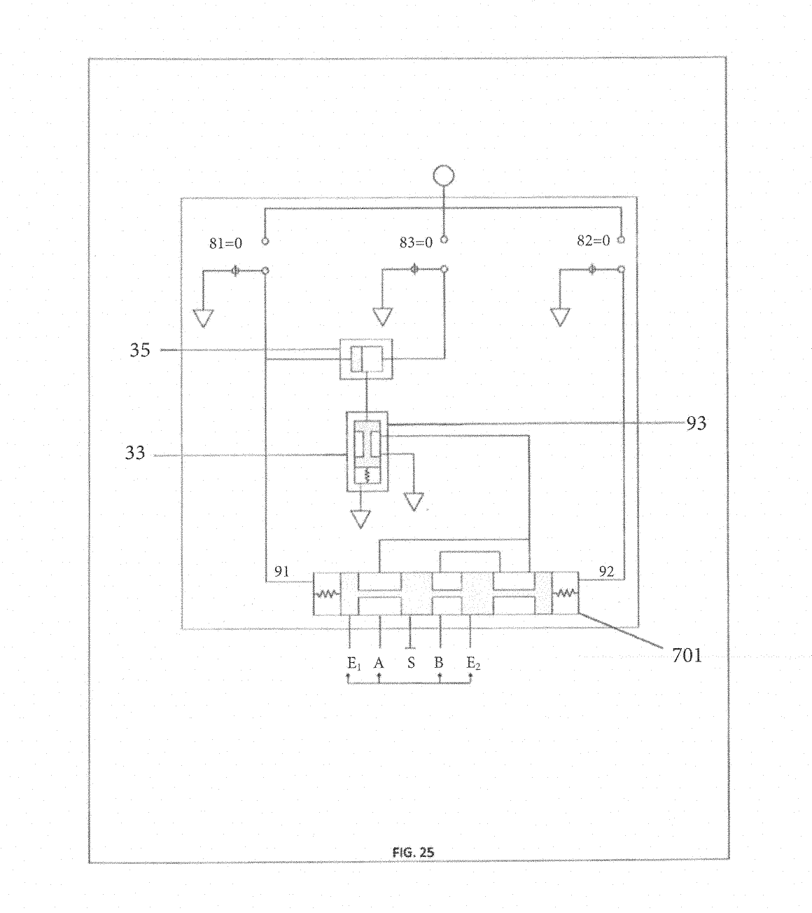

FIG. 18 is an enhanced flow-determining schematic diagram that shows another preferred embodiment of the 5-port valve 501. Note that in embodiment valve 501 shown in FIG. 18, valve spool 50 comprises five spool lobes 51-55. Valve 501 includes sealing elements 70 affixed to the radially-projecting perimeter surfaces 58 of lobes 51-55 of spool 50 in order to preclude fluid flow across the boundary established by the inner surface 61 of the spool chamber 62 of valve body 60 and a respective sealing element on the perimeter surface 58 of any of spool lobes 51-55. The configuration of spool geometry and spool sealing elements shown in FIG. 18 provides the same 3-position port connectivity of the present invention valve 201 described above and shown in FIG. 5.

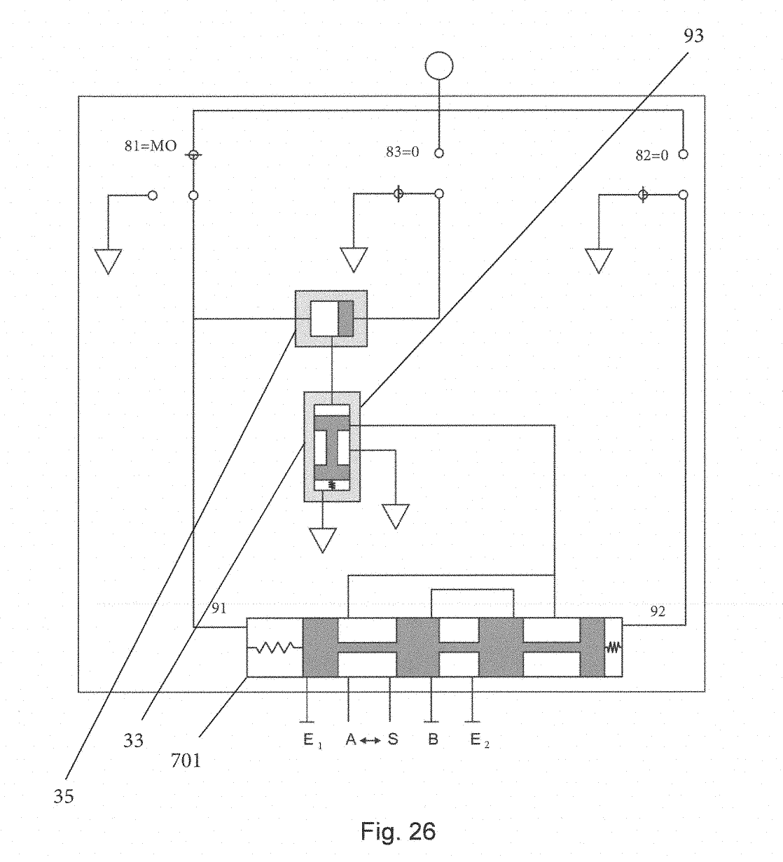

In any of the embodiment valves described herein the spool can be moved between the first, second, and third positions manually or by other actuation, such as by electrically-actuated solenoids. In a preferred embodiment, spool 50 is moved between positions within valve body 60 via a pilot-actuated solenoid configuration, in which electrically-actuated solenoids control a pilot flow of compressed gas, such that each respective pilot solenoid controls the pressurization or depressurization of a corresponding pilot cylinder. Such a preferred embodiment system is shown in FIGS. 19 through 21. In this preferred embodiment, the valve 601 employs first and second pilot solenoids, 81 and 82, which pressurize or depressurize a respective first and second pilot cylinder, 91 and 92, and where pressurization of each respective pilot cylinder 91, 92 pushes the spool away from that pilot cylinder. As such, energizing the first pilot solenoid 81 will result in pressurization of the first pilot cylinder 91, and simultaneous de-energizing of the second pilot solenoid 82 will result in depressurization of the second pilot cylinder 92, which will configure spool 50 in the first spool position. Pressurization of second pilot cylinder 92 and simultaneous depressurization of first pilot cylinder 91 will configure spool 50 in the second position. Spool 50 is disposed between centering spring elements 24, which return spool 50 to the center position in the absence of pilot cylinder pressurization. As such, depressurization of both pilot cylinders 91, 92 will configure valve 601 into the third position. This pilot-operated embodiment 601 of the valve is shown in schematic in the three valve positions (P1, P2, P3) in FIGS. 19 through 21, respectively, where the pilot solenoids 81, 82 are depicted in the schematic as single-pole switches that either pressurize (on logical 1) or depressurize (on logical 0) the respective pilot cylinders 91, 92.

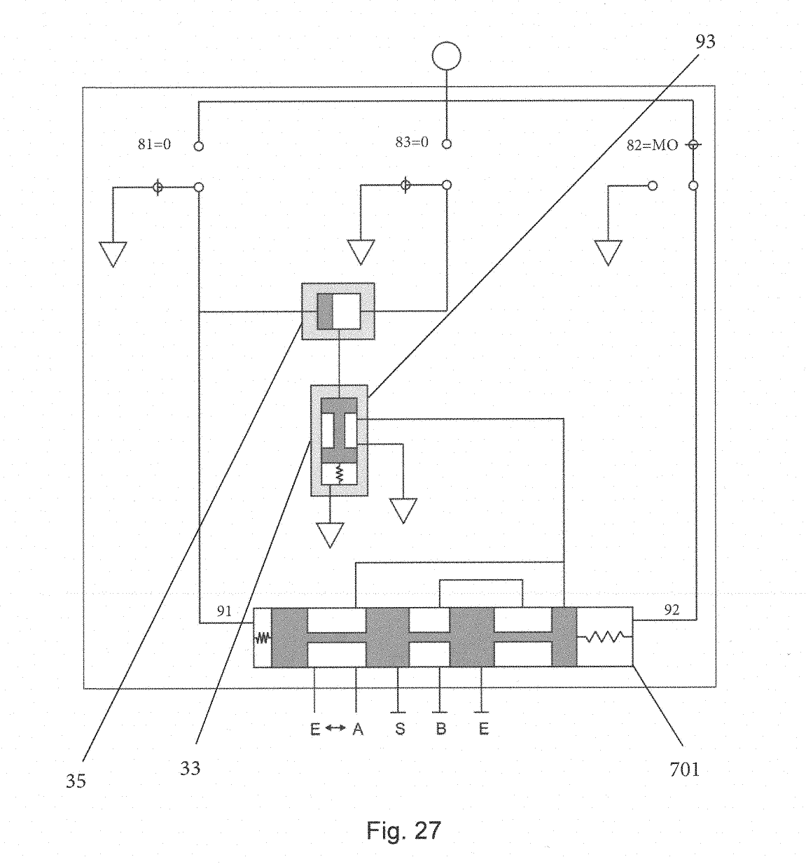

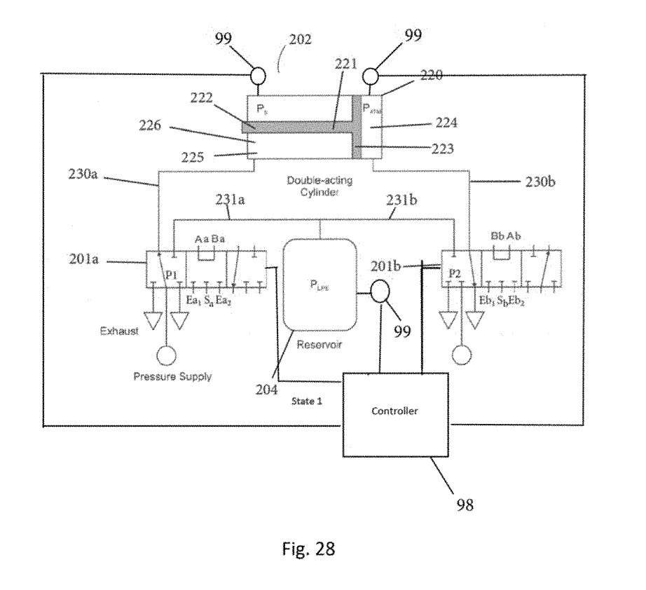

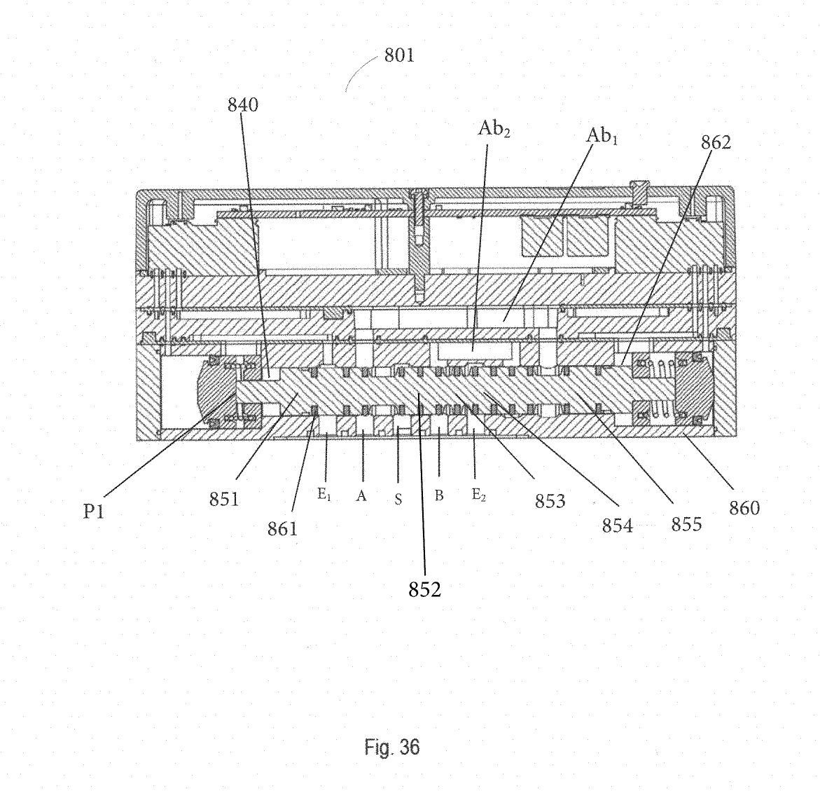

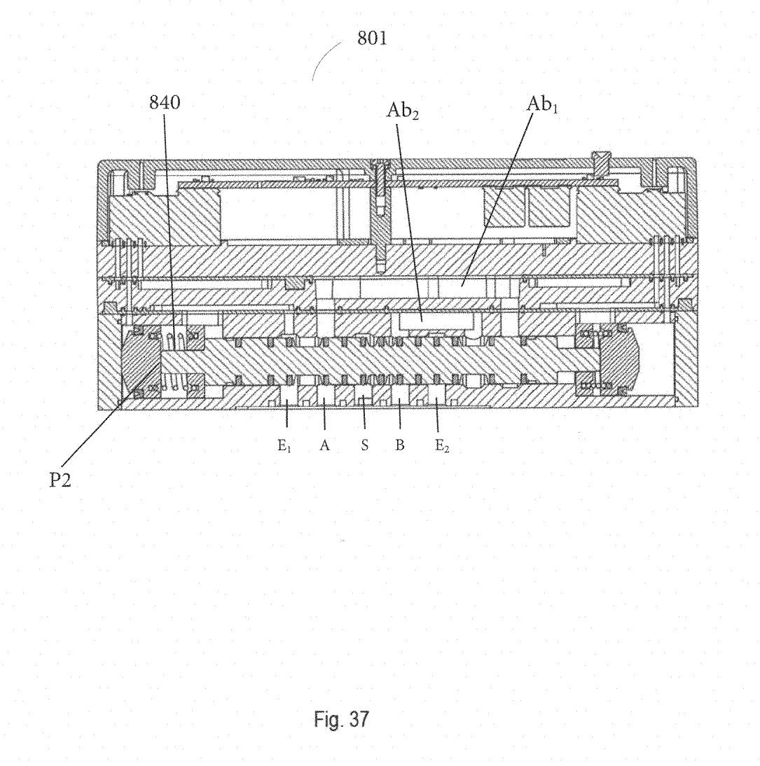

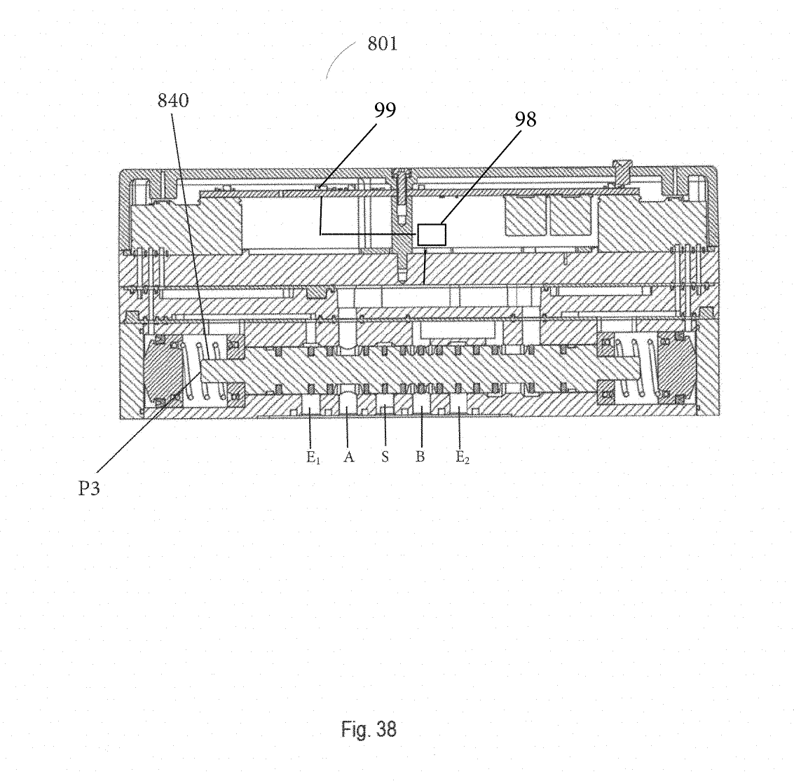

FIG. 36-38 show the three spool positions of a design embodiment 801 of the valve corresponding to the enhanced flow-determining schematic diagram shown in FIG. 18, and corresponding to the pilot-actuation circuitry shown in FIGS. 19-21. Embodiment 801 shows the invention realized in a 5-lobe spool design. Specifically, FIG. 36 shows the valve 801 with spool 840 in the first spool position P1 (positioned to the right in the drawing as shown), corresponding to the configuration shown in. FIG. 19. The five spool lobes 851-855 are shown along the length of spool 840. In a preferred embodiment, spool 840 is axisymmetric and has a circular cross-section, which facilitates positive fluid sealing between valve body 860 and spool lobes 851-855. In the preferred embodiment shown, the valve 801 includes a plurality of sealing elements 861 affixed to the radially-projecting perimeter surfaces 862 of lobes 851-855 of spool 840. This first spool position as shown in FIG. 36 provides fluid connectivity between supply port S and first outlet port A, and fluid isolation of the second outlet port B and exhaust ports E₁ and E₂. FIG. 37 shows valve 801 with spool 840 in the second spool position P2, Corresponding to the configuration shown in FIG. 20, which provides fluid connectivity between exhaust port E₁ and first outlet port A, and fluid isolation of the second outlet port B, supply port S, and exhaust port E₂. Finally, FIG. 38 shows valve 801 in the third spool position P3, corresponding to the configuration shown in FIG. 21, which provides exclusive fluid connectivity between the first outlet port A and the second outlet port B, and fluid isolation of the supply port S and exhaust ports E₁, E₂. As shown in this preferred embodiment, the exclusive fluid connectivity between first outlet port A and second outlet port B is enabled by way of the fluid connectivity between internal flow channels AB1 and AB2.

In one exemplary embodiment, a valve according to the present invention contains a pressure sensor 99 that measures fluid pressure in an internal flow channel AB1 or AB2. In this embodiment, measurement of the pressure during the first and second equilibrium states can be used to determine the first and second dwell times, respectively. Specifically, pressure measurement can be used to determine the period of time the valve should be held in the equilibration configuration when switching between the first and second valve positions. While in the equilibration configuration, the compressed air will flow between pressure vessel 3 and pressure reservoir 4 during the high-pressure equilibrium state and the low-pressure equilibrium state, until the pressure has equilibrated. The period during which this occurs is referred to as the first and second dwell times, respectively. Ideally these dwell times should be only long enough to allow equilibrium to occur. As such, in a preferred embodiment, the rate of change of pressure in an internal flow channel AB1, AB2 can be used to determine the respective durations of the first and second dwell times, respectively. For example, in one embodiment, the valve can be maintained in the third valve position (i.e., equilibrium configuration) until the rate of change of pressure in the internal flow path falls below a predetermined threshold, indicating the system has essentially established equilibrium.

In another preferred embodiment, pressure sensors 99 are used to measure the pressure at each of first and second outlet ports A, B. In another preferred embodiment, pressure sensors 99 are mounted in the pressure vessel 3 and reservoir 4. In both embodiments, the valve can be maintained in the third valve position until the pressure differential between first and second outlet ports A, B, or pressure vessel 3 and reservoir 4, falls below a predetermined threshold. In another preferred embodiment, a pressure sensor 99 is mounted in the reservoir, and the pressure equilibration process is terminated when the rate of change of pressure falls below a predetermined threshold.

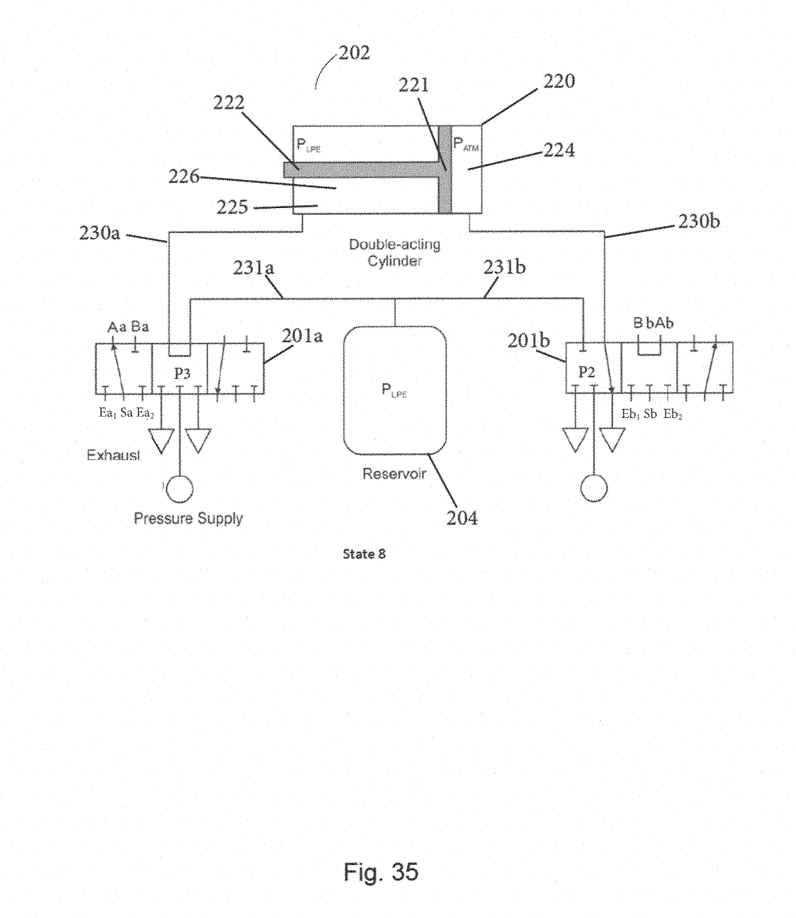

For purposes of satisfying the required dwell times, an embodiment system may include a controller 98 programmed to cause the valve to stop and remain in the third position for a specified period of time when the valve is being moved from the first position to the second position and from the second position to the first position. Embodiment inventions with a controller 98 and sensors 99 are shown in FIGS. 28 and 38. The specified period of time when moving from the first position to the second position may be different from the specified period of time when moving from the second position to the first position. In one embodiment, the controller 98 determines the specified period of time for which the valve remains in the third position based upon an input of the amount of time necessary for pressure in the pressure vessel 3 and reservoir 4 to equilibrate. In another embodiment system, the controller 98 will determine the specified period of time for which the valve remains in the third position using as an input the length of time required for the pressure difference between the pressure vessel 3 and the second reservoir 4 to fall below a predetermined threshold. In an embodiment system in which the valve includes a pressure sensor 99 at each of the first outlet port A and second outlet port. B, the controller 98 will determine the specified period of time for which the valve remains in the third position using as an input the length of time required for the pressure difference between the first outlet port A and the second outlet port B to fall below a predetermined threshold.

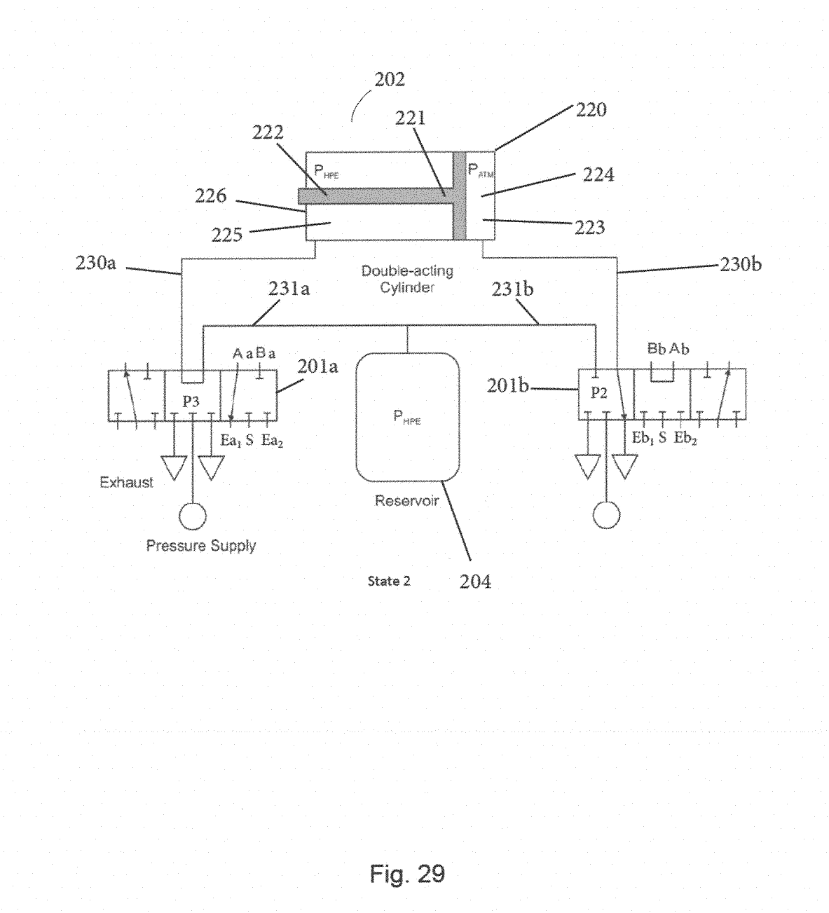

In some applications it is desirable for the valve to connect the first and second valve outlet ports A, B to an exhaust port when the valve is de-energized, such that both the pressure vessel 3 and reservoir 4 will be depressurized when the valve is de-energized. FIGS. 22 through 27 illustrate a preferred embodiment of the valve 701 that employs three electrically-actuated solenoids, 81, 82, and 83, to provide this feature. As in the previously described embodiment, first and second pilot solenoids 81, 82 respectively pressurize or depressurize a first and second pilot cylinders 91, 92. Pressurization of first pilot cylinder 91 and simultaneous depressurization of second pilot cylinder 92 will configure spool 50 in the first position, while pressurization of second pilot cylinder 92 and simultaneous depressurization of first pilot cylinder 91 will configure spool 50 in the second position. In valve 701 spool 50 is disposed between centering spring elements 24, which return spool 50 to the center position in the absence of pilot cylinder pressurization. As such, depressurization of first and second pilot cylinders 91, 92 will configure valve 701 into the third position.

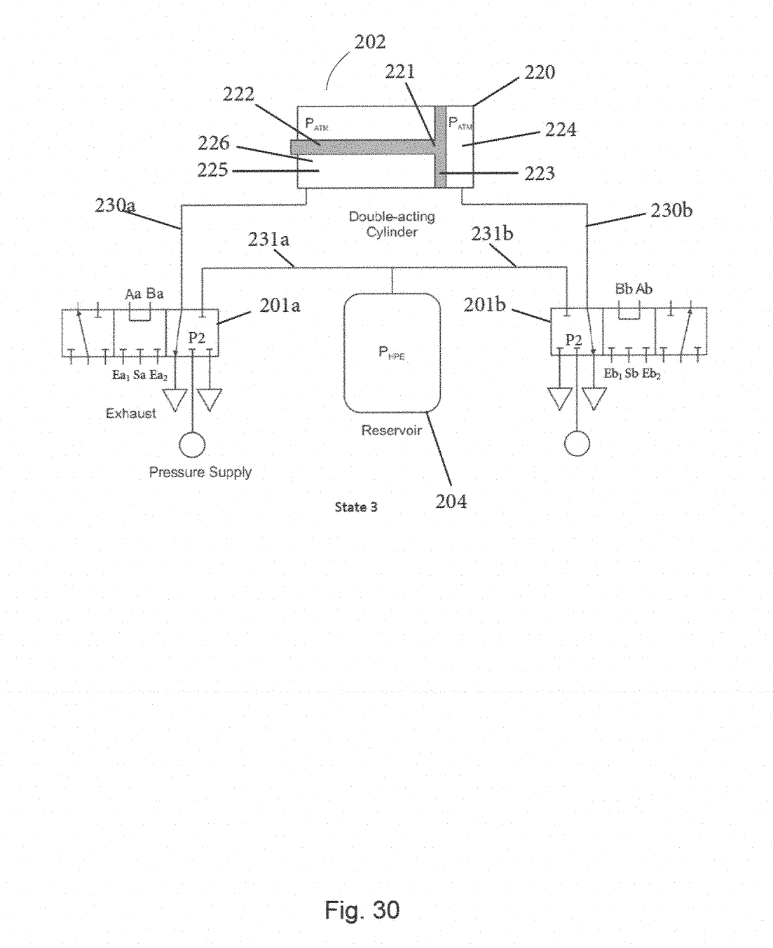

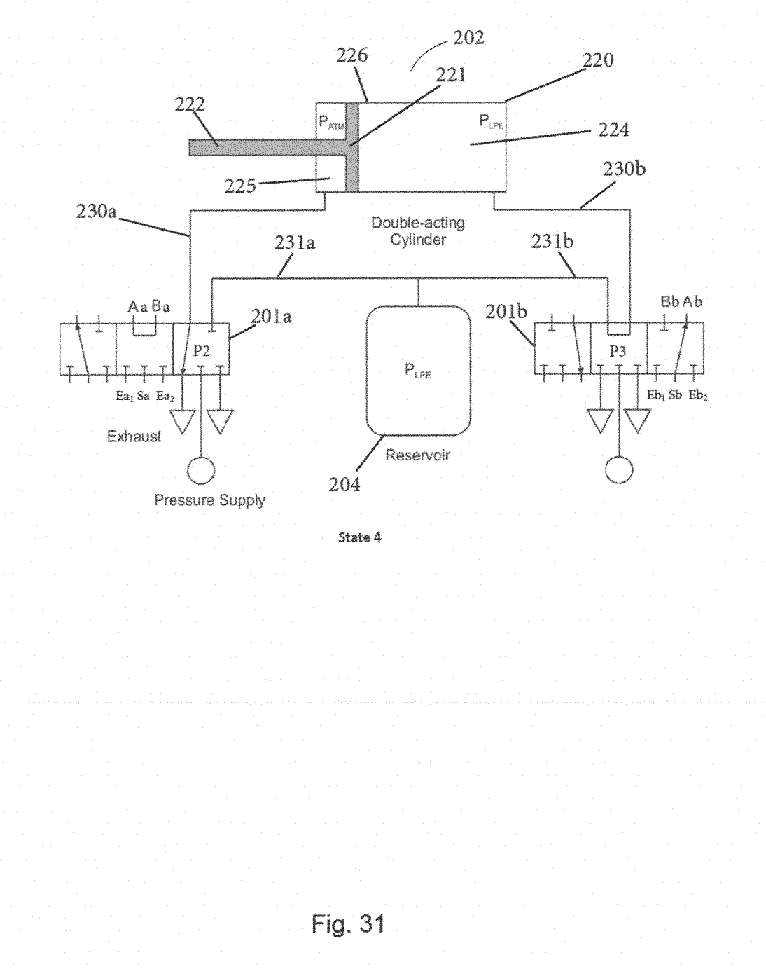

Unlike the previously described embodiment, the preferred embodiment valve 701 shown in FIGS. 22 through 27 additionally employs a pilot-operated, 2-position, spring-return, 2-way valve 33. Two-way valve 33 is moved to a first position when pilot 93 is depressurized and in a second position when the pilot 93 is pressurized. In the first position, 2-way valve 33 provides a fluid communication path between one of flow channels AB1, AB2 and an exhaust port, while in the second position valve 33 isolates the flow channels AB1, AB2 from the exhaust. Rather than be supplied directly via a pilot solenoid, 2-way valve pilot 33 is supplied by the outlet port 36 of shuttle valve 35. Shuttle valve 35 contains first and second inlet ports 37, 38. First inlet port 37 is connected to the outlet of the first pilot solenoid 81, and second inlet port 38 is connected to the outlet of the third pilot solenoid 83. During typical operation of embodiment valve 701, third solenoid 83 is constantly energized, which in turn pressurizes 2-way valve pilot 33, configures the 2-way valve in the second position, and isolates the internal flow channels AB1, AB2 from exhaust. As such, when third solenoid 83 is energized, embodiment valve 701 shown in FIGS. 22 through 27 operates in a similar manner to the embodiment valve 601 of FIGS. 19 through 21. Specifically, energizing solenoid 81 and de-energizing solenoid 82 will move spool 50 to the first position (as shown in FIG. 22); de-energizing solenoid 81 and energizing solenoid 82 will move spool 50 to the second position (FIG. 23); and de-energizing both solenoids 81, 82 will move spool 50 to the third position (FIG. 24).

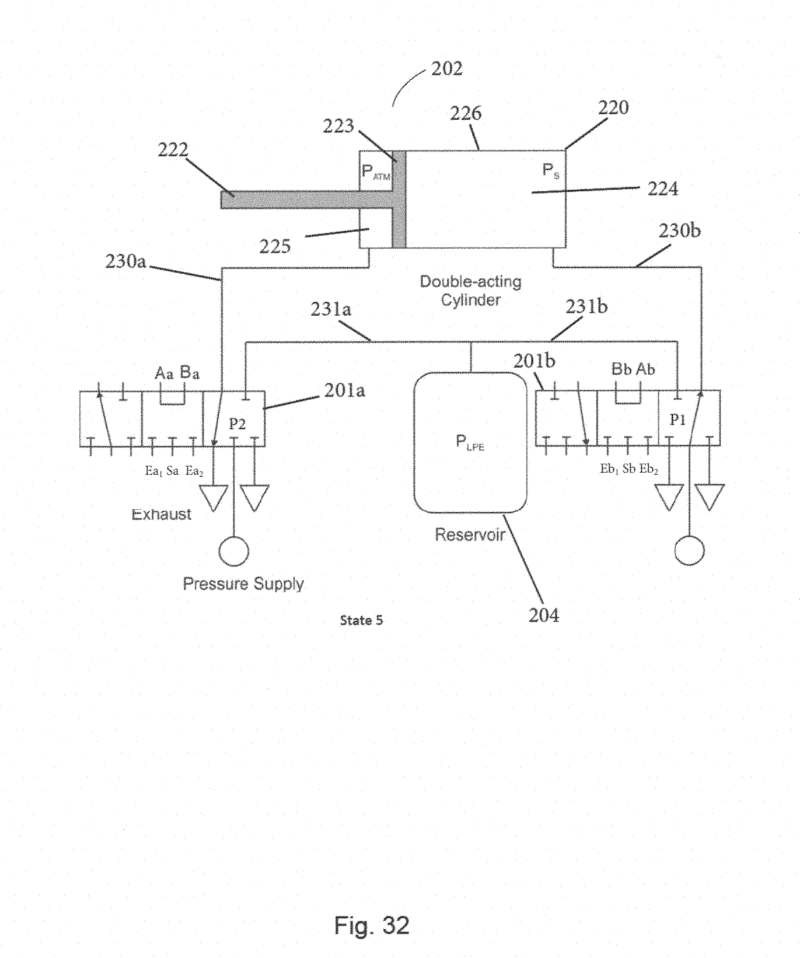

In the ease where valve 701 is de-energized, all three solenoids 81, 82 and 83 will become de-energized, such that the pilot cylinders 91, 92, and 2-way pilot 33, will all become depressurized. In this case, spool 50 will be configured in the third spool position, while 2-way valve 33 will be configured in the first position, the combination of which will provide fluid communication between both the first and second outlet ports A, B and an exhaust port, as illustrated in FIG. 25. As such, both pressure vessels 3 and reservoir 4 will be exhausted when the valve is de-energized.

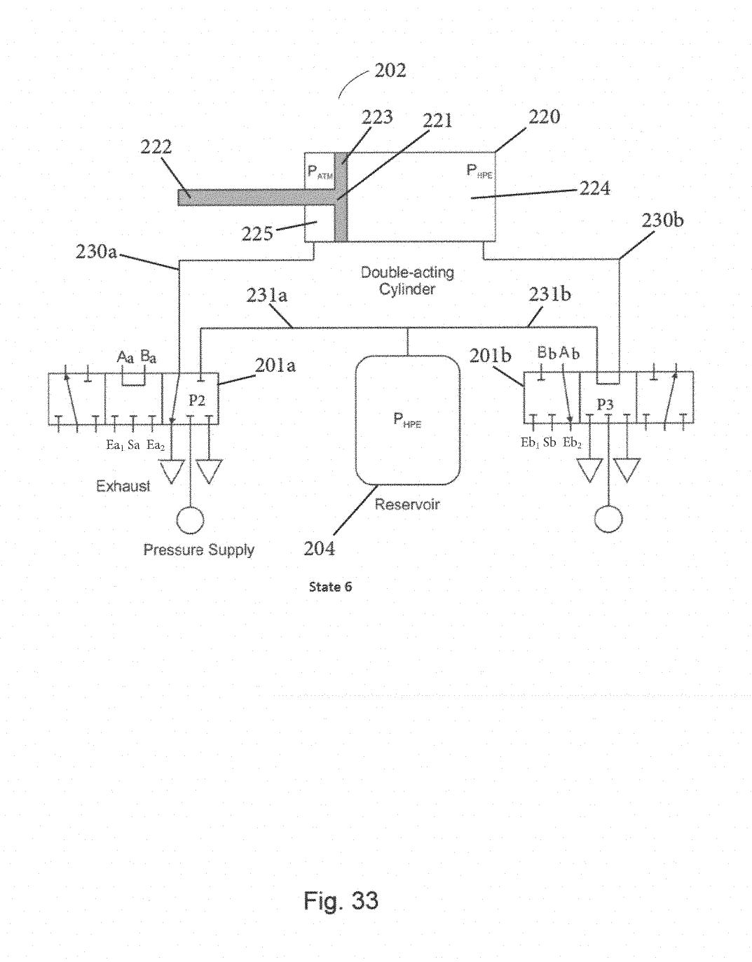

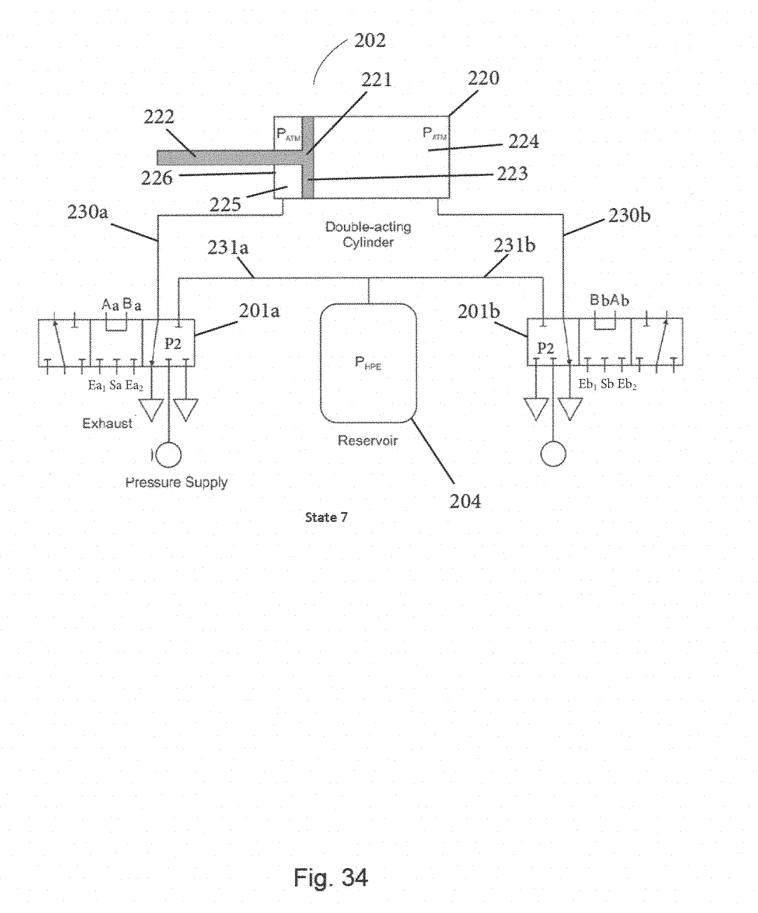

It is also desirable in the embodiment valve 701 to indirectly manually move spool 50 into the first or second position via manual overrides employed in solenoids 81, 82. When using manual overrides, valve 701 should be movable into the first or second spool positions while third solenoid 83 is de-energized. As shown in FIG. 26, manually energizing solenoid 81 with a manual override command enables solenoid 81 to pressurize first pilot cylinder 91 and moves spool 50 into the first position, and also results in pressurization of shuttle valve 35, which moves 2-way valve 33 into the second position and prevents fluid communication between supply port S and exhaust ports E₁, E₂, and thus provides full compatibility with first position port connectivity. Finally, as shown in FIG. 27, manually energizing solenoid 82 with a manual override command enables solenoid 82 to pressurize second pilot cylinder 92 and move spool 50 into the second position, thus providing full compatibility with second position port connectivity.

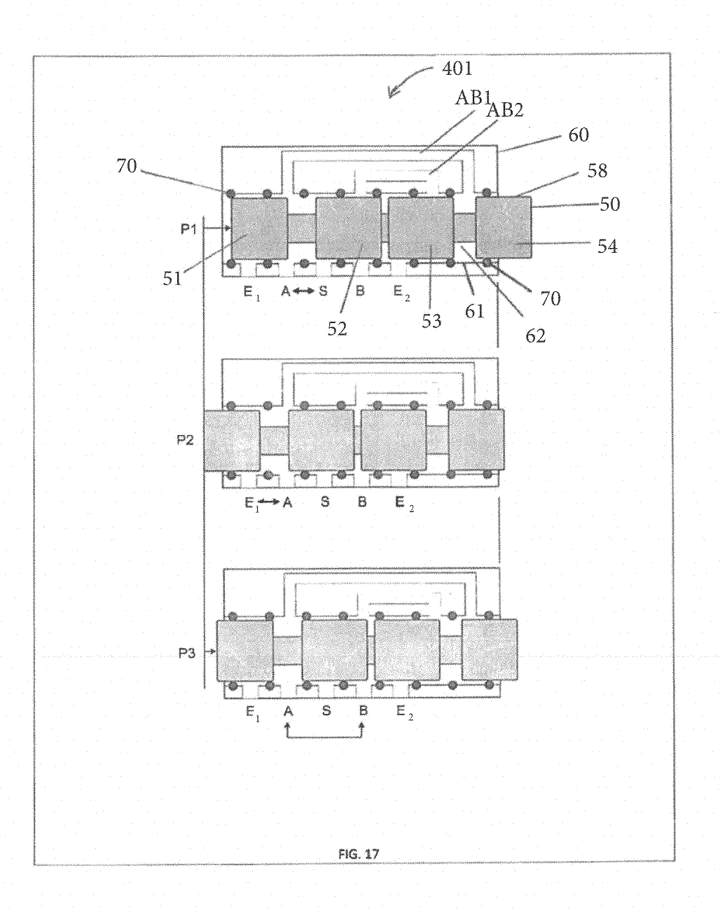

Another exemplary application of the present invention valve is in the actuation of a single-acting pneumatic actuator. Such an actuator 20 is shown in FIGS. 10-15. A single-acting pneumatic actuator is one that is configured into one of two piston positions, which. In general are a first actuator position and second actuator position, respectively. In the case of a linear actuator (often referred to as a “pneumatic cylinder”) 20, these two positions can he regarded as retraction and extension, respectively, of the piston and rod assembly 21 (the assembly 21 comprising piston 22 and rod 23). A single-acting pneumatic actuator 20 is actuated by a single compressed gas line 30, wherein compressed gas (typically air) is used to effect either the retraction or extension stroke of a piston and rod assembly 21 within cylinder 26 of actuator 20. A spring element 24 is used to provide a return force for the return stroke (i.e., extension or retraction, respectively). The repeated extension and retraction of the piston and rod assembly 21 requires repeated charging and discharging of the compressed gas side chamber 25 of the cylinder 26.

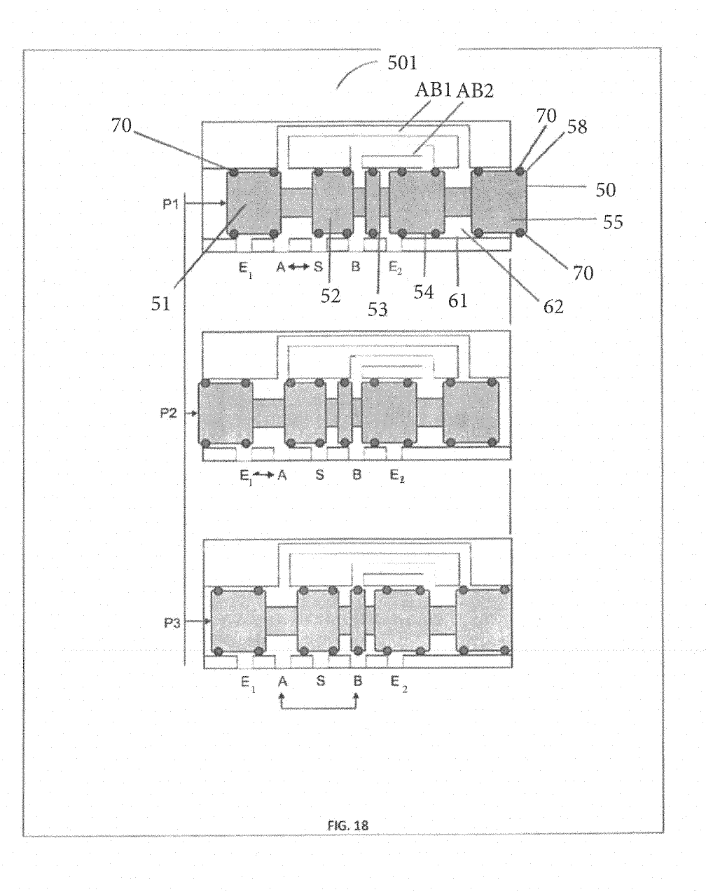

The repeated charging and discharging of actuator 20 is typically implemented with a standard 3-way control valve 1, configured as shown in FIGS. 10 and 11. For purposes of illustration, the configuration shown depicts actuator 20 for which pressurization of chamber 25 of cylinder 26 causes retraction of the piston and rod assembly 21 while depressurization of chamber 25 of cylinder 26 allows spring element 24 to return piston and rod assembly 21 to the extension configuration. It is understood, however, that the method applies equally to other configurations, such as those for which pressurization results in extension of the rod 23. As shown in FIG. 10, in order to configure the actuator 20 into a first position, chamber 25 of cylinder 26 is charged by configuring the 3-way valve 1 into the first valve position, such that chamber 25 of cylinder 26 is pressurized, rod 23 retracted, and return spring 24 compressed. As shown in FIG. 11, in order to configure actuator 20 into a second position, charged chamber 25 of cylinder 26 is discharged by configuring valve 1 into the second position, such that the gas in chamber 25 of cylinder 26 is exhausted, allowing spring 24 to return the piston and rod assembly 21 to the extended (i.e., depressurized) configuration. During the course of the repeated extension and retraction cycle illustrated in FIGS. 10 and 11, the entire mass of compressed gas contained within chamber 25 of cylinder 26 is vented to atmosphere after each cycle. Rather than discard the entire mass of compressed gas during each discharge phase of the cycle, it is desirable to reduce the consumption of compressed air by temporarily storing a portion of the compressed gas during the discharge process, and subsequently reusing a portion of the stored compressed gas during the following charging portion of the cycle. It is further desirable to perform the storage and reuse of compressed gas with a minimal amount of additional apparatus, and with minimal requirement for system reconfiguration, relative to a conventional implementation. The present invention valve provides for an apparatus, system and method that enables such storage and reuse of compressed gas in applications involving the repeated charge and discharge of single-acting cylinders.

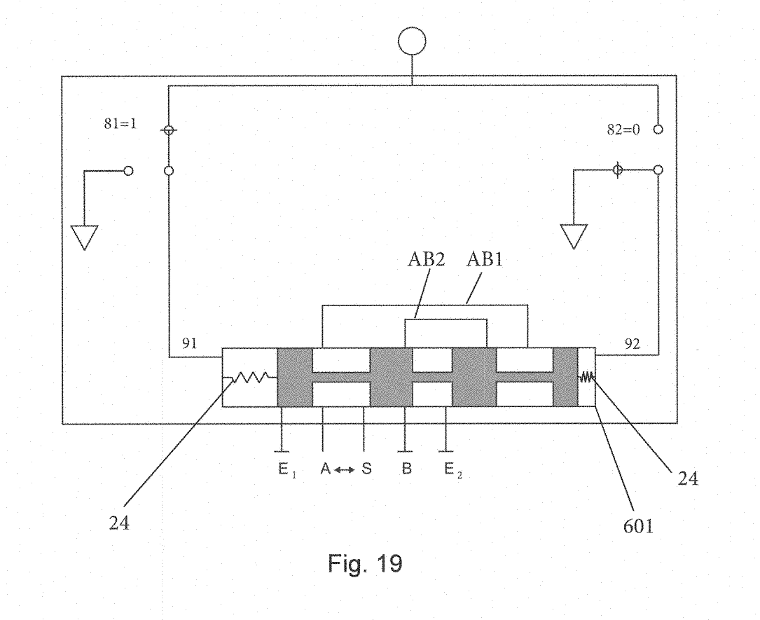

FIGS. 12 through 15 illustrate an exemplary circuit configuration 2a in which a valve 201 according to the invention controls the repeated charge and discharge of a single-acting pneumatic actuator 20 (i.e., the repeated configuring of the actuator between a first and second actuator position). Thus, the embodiment inventive system of FIGS. 12-15 includes valve 201 fluidly connected to fluid supply 5, reservoir 4 and actuator 20. Similar to the fixed-volume pressure-vessel case, relative to the standard configuration, the energy-saving configuration requires that the standard 3-way control valve be replaced with an control valve according to the present invention, and requires the addition of a supplemental pressure reservoir. As with a standard 3-way control valve, actuator 20 is configured into a first actuator position (i.e., a charged or pressurized state) by configuring the valve into the first valve position P1. In the first position, the valve provides the same connectivity between the first outlet port (A) and the supply port (S) as does a conventional 3-way control valve in the first position, in which the first outlet port is connected to the supply port, resulting in charging (i.e., pressurization) of chamber 25 of cylinder 26, and in this case, retraction of rod 23, as illustrated in FIG. 12. In addition to the connectivity between the first outlet port and supply port, the embodiment valve also isolates all other ports (i.e., both exhaust ports and the second outlet port).

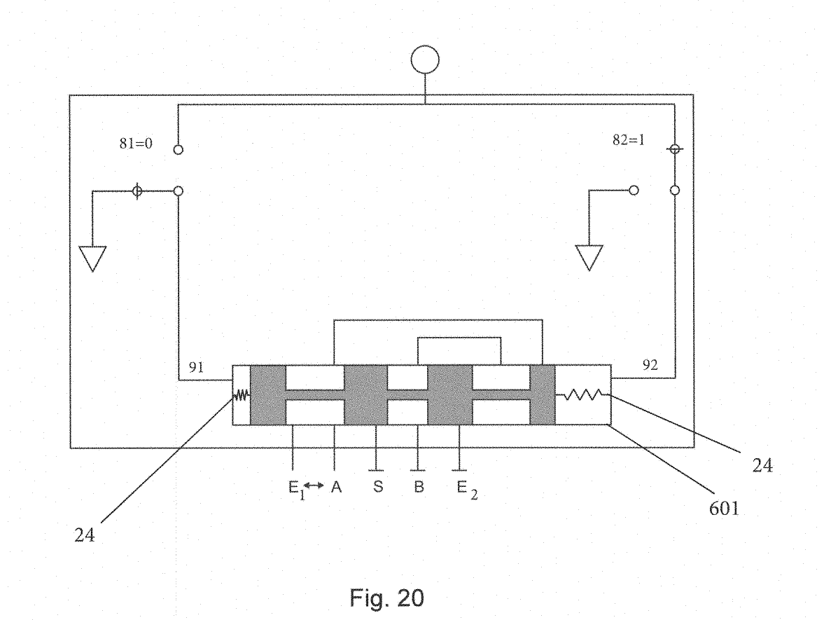

Actuator 20 is configured from the first actuator position (i.e., charged cylinder) into the second actuator position (i.e., discharged cylinder) via a two-step process, in which the embodiment valve 201 is initially configured from the first valve position P1 into the third valve position P3. As shown in FIG. 13, placing the valve 201 into the third position P3 connects the first and second outlet ports A, B, while isolating each of the supply port S and exhaust port E₁, E₂. This port connectivity enables an equilibration of the pressures in chamber 25 of cylinder 26 and reservoir 4, and because the pressure in chamber 25 of cylinder 26 is initially at the supply pressure, the port connectivity configuration Will result in compressed gas flow from chamber 25 of cylinder 26 to reservoir 4. The equilibrium pressure is referred to in this state as the high-pressure equilibrium pressure. Note that, as discussed subsequently, the return spring force as typically configured is small. As such, in cases where the external load on actuator 20 is insufficient to overcome the force resulting from the high-pressure pressure, piston and rod assembly 21 will not move while in this state (i.e., the volume of chamber 25 of cylinder 26 will remain as in the fully pressurized state).

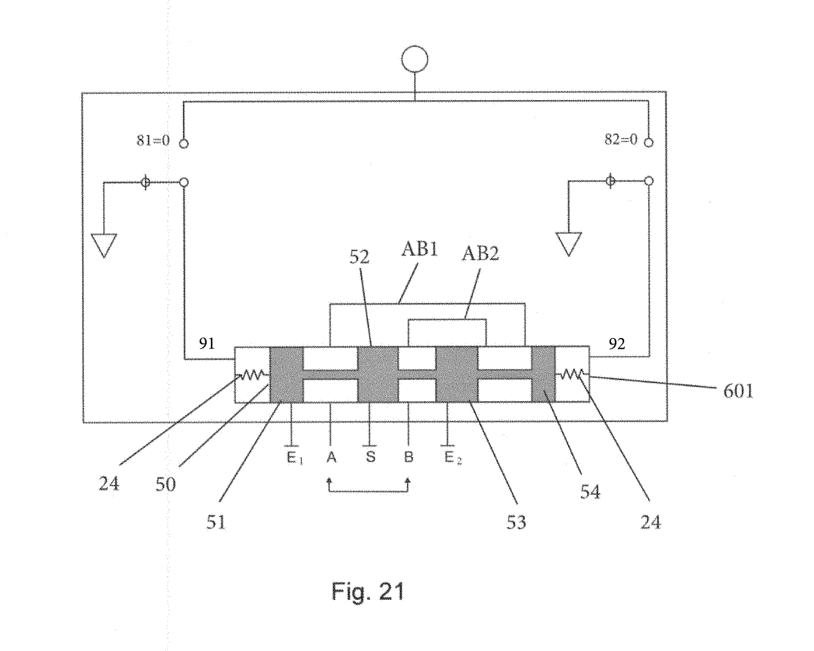

Following a sufficient period of time in the third position P3 (referred to here as the first dwell time), which allows for compressed gas flow into reservoir 4), the discharge process is completed by moving valve 201 into the second position P2, as show s in FIG. 14. In the second position, valve 201 provides the same connectivity between first outlet port A and first exhaust port E₁ as does a conventional 3-way valve in the second position. As such in that position, first outlet port A is connected to exhaust port E₁, and the remaining mass of compressed gas in actuator 20 is discharged to atmosphere (i.e., depressurized), allowing return spring 24 to configure the piston and rod assembly 21 into the second actuator position. Note that, in addition to the connectivity between first outlet port A and first exhaust port E₁, valve 201 also isolates all other ports (i.e., the second outlet port B, supply port S, and second exhaust port E₂).

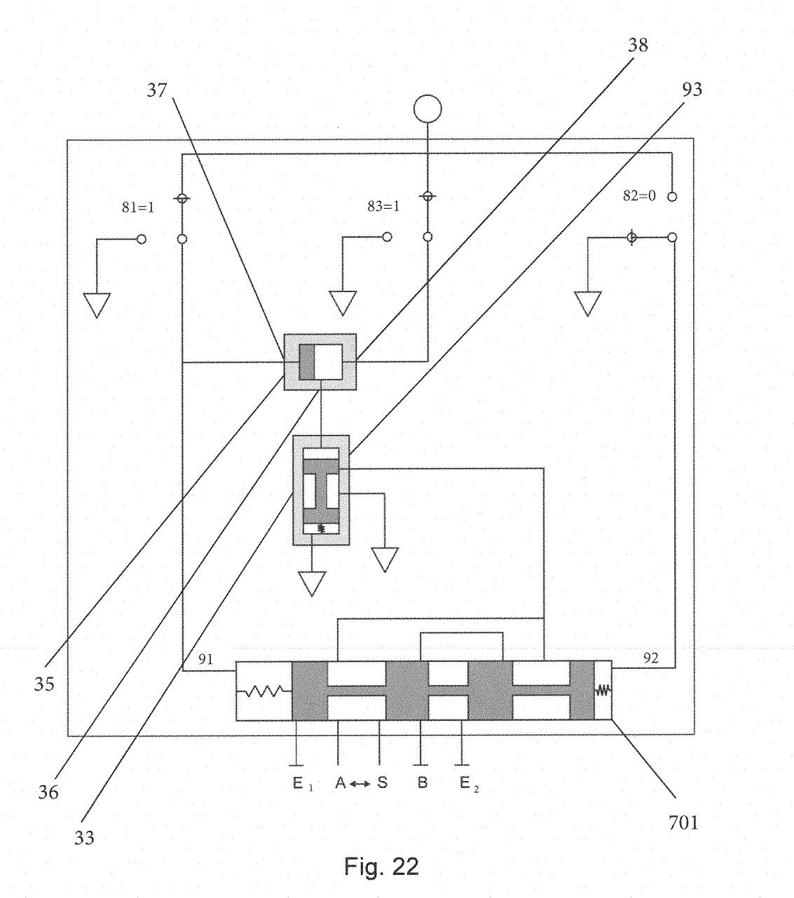

The process of configuring the cylinder from the second actuator position (i,e., cylinder depressurization) back to the first actuator position is initiated by temporarily switching control valve 201 from the second valve position P2 to the third position P3, which as shown in FIG. 15, connects the first and second outlet ports A, B, while isolating the supply port S and exhaust ports E₁, E₂. This port connectivity enables an equilibration of the pressures between reservoir 4 and cylinder 26. Because cylinder 26 is currently at atmospheric pressure while reservoir 4 is currently at the high-pressure equilibrium pressure, compressed gas will flow from reservoir 4 to cylinder 26. Note also that, at the onset of this state, actuator 20 is in the second actuator position (i.e., the spring is extended), and the volume of chamber 25 is small. As noted, return spring 24 force as typically configured is small. Accordingly, in cases for which the low-pressure equilibrium pressure is sufficient to overcome return spring 24 and actuator 20 load, actuator 20 will be moved by the low-pressure equilibrium pressure into the first actuator position (i.e., the same as in the fully charged and first equilibrium states). The process of moving actuator 20 fully into the first actuator position (i.e., with full actuation force) is completed by moving valve 201 back to first position P1, as shown in FIG. 12, such that the charge/discharge cycle can be repeated.

Note that the model of compressed gas saving when using the present invention valve to control the movement of a single-acting cylinder is somewhat different from the model of compressed gas savings in fixed-volume chambers described by equations (1) through (19). In particular, the volume of the cylinder (i.e., gas side chamber 25 in the previously described model) may vary during the charge/discharge cycle as a function of the force/displacement characteristics of returns spring 24 and external actuator load. Specifically, relative to the fully pressurized volume of cylinder 26 (i.e., FIG. 12), the volume of chamber 25 during the first (i.e., high-pressure) equilibrium could be less than the fully pressurized volume, which would result in an increased mass of compressed gas stored in reservoir 4 (relative to the fixed-volume model). This would result in an increased amount of compressed gas mass stored in the reservoir 4, relative to the fixed-volume model. However, during the second (i.e., low-pressure) equilibrium state, the volume of chamber 25 could be further reduced, which would reduce the amount of compressed gas recycled from the reservoir 4 to the chamber 25 of cylinder 26, relative to the fixed-volume model.

In general, the counteracting contributions to compressed gas savings will result in a decrease in expected saving relative to the fixed-volume model. Despite this, the return force provided by the spring element in a typical single-acting cylinder is much smaller than the actuation force resulting from pressurization of the cylinder. Although the ratio is dependent on the design of the cylinder and the supply pressure, a typical ratio of maximum spring force to actuation force is less than 10%. Under such conditions, as long as the ratio of reservoir to cylinder volume results in a low-pressure equilibrium pressure greater than 10% of the supply pressure (which would be expected for any realistic implementation), the volume will not vary appreciably between the charged and equilibrium states as a result of the return spring influence, and therefore the expected compressed gas saving would be essentially the same as the savings predicted by the fixed-volume model. Thus, the expected compressed gas savings will depend upon the nature of the external loads on the actuator.

Maximum savings will be obtained in cases where the low-pressure equilibrium is sufficient to configure the actuator into the first actuator position (i.e., into the fully pressurized configuration). In the case of equal reservoir and cylinder volumes(i.e., V_{R}=1), the low-pressure equilibrium pressure will converge to approximately one half of the supply pressure, as given by equation (18). As such, applications that will optimally benefit from a valve according to the present invention will require that the actuator be configured into the first actuator position at approximately one half the supply pressure. Although such an application may be served by lowering the supply pressure corresponding to a given actuator, doing so requires additional cost (i.e., a localized pressure regulator) and complexity. Further, supply pressure is often restricted to he uniform across multiple valves, particularly when mounted to a common manifold. As such, a valve according to the present invention can provide compressed gas saving without requiring the supply pressure to be independently modulated for a particular actuator.

In order to minimize the requirement of connecting additional apparatus when implementing a valve according to the present invention for the control of a single-acting cylinder, a preferred embodiment valve incorporates a pressure reservoir 4 affixed to the valve, or to a manifold to which the valve is mounted. Such a configuring eliminates the requirement of additional lines and fittings between the valve manifold and the reservoir. In this preferred embodiment, the pressure reservoir is affixed (i.e., fastened) directly onto the manifold, such that a single compressed gas line connects the valve manifold and reservoir assembly with the single-acting cylinder, which is fully consistent with the connectivity between a standard 3-way valve manifold and single-acting cylinder.

The inventive system and method of temporarily storing a portion of the compressed gas during the discharge process, and subsequently reusing a portion of the stored compressed gas during the following charging portion of the cycle to reduce the consumption of compressed air can be applied in systems employing a double-acting pneumatic actuator. Embodiment systems and methods employing pneumatic circuits including such actuators 220 are shown in FIGS. 28-35.

A double-acting pneumatic actuator is one that is configured into one of two piston positions (a first actuator position and second actuator position) via pneumatic forces. In the case of linear actuator 220, these two positions can be regarded as retraction and extension of the piston and rod assembly 221 (the assembly 221 comprising rod 222 and piston 223). A double-acting pneumatic actuator 220 is actuated by compressed gas entering in from two compressed gas lines 230a, 230b, wherein compressed gas (typically air) is used to effect both the retraction and extension stroke of piston and rod assembly 221 within housing (shown as a cylinder in the drawings) 226 of actuator 220. The repeated extension and retraction of the piston and rod assembly 221 requires repeated charging and discharging of the compressed gas chambers 224, 225 of the housing 226.

FIGS. 28 through 35 depict an exemplary energy-saving circuit configuration 202 in which present invention valves 201a, 201b control the repeated charge and discharge of a double-acting pneumatic actuator 220. As seen in FIGS. 28-35, valves 201a and 201b respectively include supply ports Sa, Sb, first outlet ports Aa, Ab, second outlet ports Ba, Bb, first exhaust ports Ea₁, Eb₁ and second exhaust ports Ea₂, Eb₂. Actuator 220 of system 202 is configured into a first actuator position (chamber 225 is in a charged or pressurized state) by configuring valve 201a into first valve position P1 and valve 201b into the second valve position P2. This system configuration represents system state 1 and is illustrated in FIG. 28. In this respect, first outlet port Aa is connected to supply port Sa resulting in charging of chamber 225 of cylinder housing 226 of actuator 220 while first outlet port Ab of valve 201b is connected to second exhaust port Eb₂ allowing chamber 224 of cylinder to discharge to exhaust. In addition, the valves are configured such that they isolate all other ports. Valve 201a is connected to reservoir 204 via line 231a and valve 201b is connected to reservoir 204 via line 231b.

Actuator 220 is configured from the first actuator position (i.e., charged chamber 225/discharged chamber 224) into the second actuator position (i.e., discharged chamber 225/charged chamber 224) via a multi-step process, in which valve 201a is initially configured from the first valve position into the third valve position. This system configuration represents system state 2 and is illustrated in FIG. 29. As shown in FIG. 29, placing valve 201a temporarily into the third position P3 connects the first and second outlet ports, Aa, Ba while isolating each of the supply port Sa and exhaust ports Ea₁, Ea₂. This port connectivity enables an equilibration of the pressures in chamber 225 and reservoir 204 (i.e., in chamber 225 of actuator 220 and in reservoir 204). Because the pressure in chamber 225 is initially at the supply pressure, the port connectivity configuration will result in compressed gas flow from chamber 225 to reservoir 204. The equilibrium pressure is referred to in this state as the high-pressure equilibrium pressure. Note that, during the foregoing process valve 201b remains in the second position P2. Hence, chamber 224 is connected to exhaust so there is no return three acting on piston and rod assembly 221. As such, in cases where the load in chamber 224 on the actuator is insufficient to overcome the force resulting from pressure in chamber 225, piston and rod assembly 221 will not move while in this state (i.e., the chamber 225 volume of actuator 220 will remain as in the fully pressurized state).

Following a sufficient period of time in the third position P3 (referred to here as the first dwell time), which allows for compressed gas flow into reservoir 204), the discharge process is completed by moving valve 201a into the second position P2 while valve 201b remains in the second position P2. This system configuration represents system state 3 and is illustrated in FIG. 30. Note that, in addition to the connectivity between first outlet port Aa and first exhaust port Ea₁, valve 201a also isolates all other ports (i.e., the second outlet port Ba, supply port Sa, and second exhaust port Ea₂). As such in that position, first outlet port Aa is connected to exhaust port Ea₁, and the remaining mass of compressed gas in chamber 225 of actuator 220 is discharged to atmosphere (i.e., depressurized). Both chambers 224 and 225 of actuator 220 are now at atmospheric pressure.

As shown in FIG. 31, after chamber 225 discharges, valve 201b is moved to its third position P3 resulting in outlet ports Ab and Bb being in fluid communication with each other. Valve 201a remains in position P2 venting chamber 225 via outlet port Aa and subsequently through exhaust port Ea₁. This configuration of valves allows reservoir 204 to fluidly communicate with and charge chamber 224, moving piston and rod assembly 221 into the second (extended) actuator position by means of a low pressure equilibrium state (state 4).

Following a sufficient period of time in which valve 201b is in the third position P3 (referred to here as the second dwell time), which allows for compressed gas to flow into chamber 224 from reservoir 204, the charging of chamber 224 is completed by moving valve 201b into the first position P1, as shown in FIG. 32. This system configuration represents system state 5. In the first position, valve 201b provides the connectivity between first outlet port Ab and supply port Sb. As such in that position, first outlet port Ab is connected to supply port Sb, and a supply of compressed gas is delivered to chamber 224 to complete movement of piston and rod assembly 221 into the second actuator position. Note that, in addition to the connectivity between first outlet port Ab and supply Sb, valve 201b isolates all other ports (i.e., the second outlet port Rb, first exhaust port Eb₁, and second exhaust port Eb₂). During this part of the process valve 201a continues to remain in the second position P2 in which first outlet port Aa and first exhaust port Ea₁ are fluidly connected.

The process of configuring cylinder 226 from the second actuator position back to the first actuator position involves depressurizing chamber 224 and pressurizing chamber 225 and is initiated by temporarily switching control valve 201b from the first valve position P1 to the third position P3. This system configuration represents system state 6 and is illustrated in FIG. 33. During this part of the process, valve 201a continues to remain in the second position P2 in Which first outlet port Aa and first exhaust port Ea₁ are fluidly connected. The configuration of valve 201b connects first and second outlet ports Ab, Bb, while isolating the supply port Sb and exhaust ports Eb₁, Eb₂. This port connectivity enables an equilibration of the pressures between reservoir 204 and chamber 224 of cylinder 226. Because chamber 224 is currently at high pressure while reservoir 204 is at low pressure equilibrium, compressed gas will flow from chamber 224 to reservoir 204. Also, because chamber 225 is at atmospheric pressure, rod and piston assembly 221 will remain extended while chamber 224 and reservoir 204 are in high pressure equilibrium.

Following a sufficient period of time in which valve 201b is in the third position P3 (referred to here as the third dwell time), which allows for compressed gas to flow from chamber 224 into reservoir 204, the discharging of chamber 224 is completed by moving valve 201b into the second position P2, as shown in FIG. 34. This figure depicts system state 7. In this position first outlet port Ab of valve 201b is in fluid communication with second exhaust port Eb₂, allowing chamber 224 to discharge to atmosphere. Valve 201a continues to remain in the second position P2 in which first outlet port Aa and first exhaust port Ea₁ are fluidly connected. Thus, at this state, chambers 224 and 225 of actuator 220 are each at atmospheric pressure.

The final step of configuring actuator 220 from the second actuator position back to the first actuator position involves temporarily switching control valve 201a from the second valve position P2 to the third position P3 for a short period of time (referred to here as the fourth dwell time), which allows compressed air n reservoir 204 to flow into chamber 225. This state (state 8) is shown in FIG. 35. During this part of the process valve 201b remains in the first position P2 in which first outlet port Ab and second exhaust port Eb₂ are fluidly connected, while isolating supply port Sb, outlet port Bb and exhaust port Eb₁. This port connectivity of valves 201a and 201b enables an equilibration of the pressures between reservoir 204 and chamber 225 of actuator 220. The charge/discharge cycle can then be repeated.

In the system shown in FIGS. 28-35, the reservoir can include a pressure sensor 99 to control timing of the dwell periods. The reservoirs may also include additively or separately, a ball valve to empty the reservoirs if needed. While exemplary embodiments are described herein, it will be understood that various modifications to the systems and methods described can be made without departing from the scope of the invention. The foregoing detailed description has been given for clearness of understanding only, and no unnecessary limitations should be understood therefrom, as modifications will be obvious to those skilled in the art.

What is claimed is:

1. A valve for controlling the flow of a fluid, the valve comprising:
a valve body and a flow diverter disposed within the valve body and movably positionable within the valve body such that the flow diverter can assume a first position, a second position and a third position;
the valve body comprising a plurality of external ports, the plurality of external ports comprising a supply port, a first outlet port, and a second outlet port and one or more exhaust ports;
the flow diverter being disposed within the valve body such that:
a) when the flow diverter is in the first position, the supply port and the first outlet port are in fluid communication with each other and the one or more exhaust ports and second outlet port are in fluid isolation;
b) when the flow diverter is in the second position, the first outlet port and one of the one or more exhaust ports are in fluid communication with each other and the supply port and the second outlet port are in fluid isolation; and
c) when the flow diverter is in the third position, the first outlet port and the second outlet port are in fluid communication with each other and the supply port and the one or more exhaust ports are in fluid isolation.

2. A valve for controlling the flow of a fluid, the valve comprising:
a body having a first end and an second end;
a spool within the body, the spool being movable within the body and capable of being moved to a first spool position, a second spool position and a third spool position;
the third spool position being physically located between the first spool position and the second spool position;
the body comprising a plurality of external ports, the plurality of external ports comprising a supply port, a first outlet port, and a second outlet port and one or more exhaust ports;
the spool being disposed within the body such that:
a) when the spool is in the first position, the supply port and the first outlet port are in fluid communication with each other and the one or more exhaust ports and second outlet port are in respective fluid isolation;
b) when the spool is in the second position, the first outlet port and one of the one or more exhaust ports are in fluid communication with each other and the supply port and the second outlet port are in respective fluid isolation; and
c) when the spool is in the third position, the first outlet port and the second outlet port are in fluid communication with each other and the supply port and the one or more exhaust ports are in respective fluid isolation.

3. The valve of claim 2, wherein:
the one or more exhaust ports number two exhaust ports, the two exhaust ports comprising a first exhaust port and a second exhaust port;
the first exhaust port, the supply port, the first outlet port, the second outlet port and the second exhaust port are arranged sequentially between the first end of the body and the second end of the body; and
when the spool is in the first position, the first outlet port and the supply port are in fluid communication with each other and the one or more exhaust ports and the second outlet port are in respective fluid isolation;
when the spool is in the second position, the first outlet port and the first exhaust port are in fluid communication with each other and the supply port, the second exhaust port, and second outlet port are in respective fluid isolation; and
when the spool is in the third position, the first outlet port and second outlet port are in fluid communication with each other and the supply port and the one or more exhaust ports are in respective fluid isolation.

4. The valve of claim 3 further comprising seven internal ports arranged sequentially between the first end of the body and the second end of the body; and
wherein the first, second, third, fourth, fifth, sixth, and seventh internal ports are in fluid communication respectively with the first exhaust port, the first outlet port, the supply port, the second outlet port, the second exhaust port, the second outlet port and the first outlet port.

5. The valve of claim 4 wherein the spool includes a first, second, third, and fourth lobe arranged sequentially along the length of the spool.

6. The valve of claim 5 wherein the spool has a length along which lies a long axis and the spool is axisymmetric along the long axis of the spool.

7. The valve of claim 5 wherein in the first spool position:
the first internal port is isolated by the first spool lobe;
the second and third internal ports are in fluid communication between the first and second spool lobes;
the fourth internal port is isolated by the second spool lobe;
the fifth internal port is isolated between the second and third spool lobes;
the sixth internal port is isolated by the third spool lobe; and
the seventh internal port is isolated between the third and fourth spool lobes.

8. The valve of claim 5 wherein in the second spool position:
the first and second internal ports are in fluid communication between the first and second spool lobes;
the third internal port is isolated by the second spool lobe;
the fourth internal port is isolated between the second and third spool lobes;
the fifth internal port is isolated by the third spool lobe;
the sixth internal port is isolated between the third and fourth spool lobes; and
the seventh internal port is isolated by the fourth spool lobe.

9. The valve of claim 5 wherein in the third spool position:
the first internal port is isolated by the first spool lobe;
the second internal port is isolated between the first and second spool lobes;
the third internal port is isolated by the second spool lobe;
the fourth internal port is isolated between the second and third spool lobes;
the fifth internal port is isolated by the third spool lobe; and
the sixth and seventh internal ports are in fluid communication between the third and fourth spool lobes.

10. The valve of claims 5 further comprising:
one or more spool biasing elements;
a first pilot cylinder and second pilot cylinder;
a first pilot solenoid valve and a second pilot solenoid valve, the first and second pilot solenoid valves respectively pressurizing and depressurizing the first and second pilot cylinders; and
wherein:
the spool is moved to the first position when the first pilot cylinder is pressurized and the second pilot cylinder is de-pressurized;
the spool is moved to the second position when the second pilot cylinder is pressurized and the first pilot cylinder is de-pressurized; and
the spool is moved to the third position by the one or more spool biasing elements when the first and second pilot cylinders are both depressurized.

11. The valve of claim 10 wherein:
the valve further comprises within the body:
a third pilot solenoid valve;
a shuttle valve comprising a first inlet port, a second inlet port and an outlet port; and
a spring-return pilot-operated 2-way valve controlled by a third pilot cylinder;
the third pilot cylinder is in fluid communication with the outlet port of the shuttle valve;
the first inlet port of the shuttle valve is in fluid communication with the first pilot cylinder; and
the second inlet port of the shuttle valve is pressurized or depressurized by the third pilot solenoid valve; and
wherein:
when the first pilot cylinder is pressurized and the second pilot cylinder is depressurized the spool moves to the first position;
when the second pilot cylinder is pressurized and the first pilot cylinder is depressurized the spool moves to the second position;
when the first and second pilot cylinders are depressurized the spool is moved to the third position by the one or more spool biasing elements; and
the spring-return pilot-operated 2-way valve controls fluid communication between the first outlet port and the exhaust port, such that:
a) the first outlet port and the exhaust port are not in fluid communication when the third pilot cylinder is pressurized; and
b) the first outlet port and the exhaust port are in fluid communication when the third pilot cylinder is depressurized.

12. The valve of claim 4 wherein the spool includes a first, second, third, fourth and fifth lobe arranged sequentially along the length of the spool.

13. The valve of claim 12 wherein the spool has a length along which lies a long axis and the spool is axisymmetric along the long axis of the spool.

14. The valve of claim 12 wherein in the first spool position:
the first internal port is isolated by the first spool lobe;
the second and third internal ports are maintained in fluid communication between the first and second spool lobes;
the fourth internal port is isolated between the second and third spool lobes;
the fifth internal port is isolated between the third and fourth spool lobes;
the sixth internal port is isolated by the fourth spool lobe; and
the seventh internal port is isolated between the fourth and fifth spool lobes.

15. The valve of claim 12 wherein in the second spool position:
the first and second internal ports are in fluid communication between the first and second spool lobes;
the third internal port is isolated between the second and third spool lobes;
the fourth internal port is isolated between the third and fourth spool lobes;
the fifth internal port is isolated by the fourth spool lobe;
the sixth internal port is isolated between the fourth and fifth spool lobes; and
the seventh internal port is isolated by the fifth spool lobe.

16. The valve of claim 12 wherein in the third spool position:
the first internal port is isolated by the first spool lobe;
the second internal port is isolated between the first and second spool lobes;
the third internal port is isolated by the second spool lobe;
the fourth internal port is isolated between the second and fourth spool lobes;
the fifth internal port is isolated by the fourth spool lobe; and
the sixth and seventh internal ports are in fluid communication between the fourth and fifth spool lobes.

17. The valve of claim 12 further comprising:
one or more spool biasing elements;
a first pilot cylinder and second pilot cylinder;
a first pilot solenoid valve and a second pilot solenoid valve, the first and second pilot solenoid valves respectively pressurizing and depressurizing the first and second pilot cylinders; and
wherein:
the spool is moved to the first position when the first pilot cylinder is pressurized and the second pilot cylinder is de-pressurized;
the spool is moved to the second position when the second pilot cylinder is pressurized and the first pilot cylinder is de-pressurized; and
the spool is moved to the third position by the one or more spool biasing elements when the first and second pilot cylinders are both depressurized.

18. The valve of claim 17 wherein:
the valve further comprises within the body:
a third pilot solenoid valve;
a shuttle valve comprising a first inlet port, a second inlet port and an outlet port; and
a spring-return pilot-operated 2-way valve controlled by a third pilot cylinder;
the third pilot cylinder is in fluid communication with the outlet port of the shuttle valve;
the first inlet port of the shuttle valve is in fluid communication with the first pilot cylinder; and
the second inlet port of the shuttle valve pressurizing or depressurizing by the third pilot solenoid valve; and
wherein:
when the first pilot cylinder is pressurized and the second pilot cylinder is depressurized the spool moves to the first position;
when the second pilot cylinder is pressurized and the first pilot cylinder is depressurized the spool moves to the second position;
when the first and second pilot cylinders are depressurized the spool is moved to the third position by the one or more spool biasing elements; and
the spring-return pilot-operated 2-way valve controls fluid communication between the first outlet port and the exhaust port, such that:
a) the first outlet port and the exhaust port are not in fluid communication when the third pilot cylinder is pressurized; and
b) the first outlet port and the exhaust port are in fluid communication when the third pilot cylinder is depressurized.

19. A system for controlling fluid pressure during an industrial application, the system comprising:
a control valve,
the control valve comprising a spool within a body;
the spool being movable within the body and capable of being moved to a first spool position, a second spool position and a third spool position, the third position being physically located between the first position and the second position;
the valve body comprising an exhaust port, a supply port, a first outlet port, a second outlet port and two internal flow channels;
the valve being configured such that:
when the valve spool is in the first position, the first outlet port and the supply port are in fluid communication with each other, and the exhaust port and second outlet port are in respective fluid isolation;
when the valve spool is the second position, the first outlet port and the exhaust port are in fluid communication with each other, and the supply port and second outlet port are in respective fluid isolation; and
when the valve spool is in the third position, the first outlet port and second outlet port are in fluid communication with each other, and the supply port and exhaust port are in respective fluid isolation; and
a first pressure vessel connected to the first outlet port and a second pressure vessel connected to the second outlet port.

20. The system of claim 19 further including a controller programmed to cause the valve to stop and remain in the third position for a specified period of time when the valve is being moved from the first position to the second position and from the second position to the first position.

21. The system of claim 20 wherein the specified period of time when moving from the first position to the second position is different from the specified period of time when moving from the second position to the first position.

22. The system of claim 20 wherein the specified period of time for which the valve remains in the third position includes an amount of time necessary for pressure in the first pressure vessel and second pressure vessel to equilibrate.

23. The system of claim wherein the specified period of time for which the valve remains in the third position includes an amount of time necessary for pressure in the first pressure vessel and second pressure vessel to equilibrate.

24. The system of claim 20 wherein the first pressure vessel and the second pressure vessel each include a pressure sensor, and the specified period of time for which the valve remains in the third position is the length of time required for the pressure difference between the first pressure vessel and the second pressure vessel to fall below a predetermined threshold while the valve is in the third position.

25. The system of claim 21 wherein the first pressure vessel and the second pressure vessel each include a pressure sensor, and the specified period of time for which the valve remains in the third position is the length of time required for the pressure difference between the first pressure vessel and the second pressure vessel to fall below a predetermined threshold while the valve is in the third position.

26. The system of claim 20 wherein the valve further includes a pressure sensor at each of the first outlet port and second outlet port, and the specified period of time for which the valve remains in the third position is the length of time required for the pressure difference between the first outlet port and the second outlet port to fall below a predetermined threshold while in the third position.

27. The system of claim 21 wherein the valve further includes a pressure sensor at each of the first outlet port and second outlet port, and the specified period of time for which the valve remains in the third position is the length of time required for the pressure difference between the first outlet port and the second outlet port to fall below a predetermined threshold while in the third position.

28. The system of claim 20 wherein the valve further includes a pressure sensor in one of the internal flow channels between the first and second outlet ports, and where the specified period of time for which the valve remains in the third position is the length of time required for the rate of pressure decay to fall below a predetermined threshold while in the third position.

29. The system of claim 21 wherein the valve further includes a pressure sensor in one of the internal flow channels between the first and second outlet ports, and where the specified period of time for which the valve remains in the third position is the length of time required for the rate of pressure decay to fall below a predetermined threshold while in the third position.

30. The system of claim 19 wherein the first pressure vessel is a single-acting type actuator and the second pressure vessel is a pressure reservoir.

31. The system of claim 30 further including a valve manifold and the pressure reservoir is mounted to the valve manifold.

32. The system of claim 31, where the pressure reservoir is mounted to the valve body.

33. A system comprising:
a fluid supply, a double-acting actuator, a first control valve, a second control valve and a fluid reservoir;
the actuator comprising a piston housing and a piston slidably moveable within the piston housing, the piston dividing the piston housing into a first chamber capable of holding a volume of fluid on a first side of the piston and a second chamber capable of holding a volume of fluid on a second side of the piston;
the first control valve being pneumatically coupled to the fluid supply, the fluid reservoir and the first chamber of the actuator;
the second control valve being pneumatically coupled to the fluid supply, the fluid reservoir and the second chamber of the actuator;
each of the first and second control valves comprising a valve body and a spool disposed within the valve body and slidably positionable within the valve body such that the spool can assume a first position, a second position and a third position;
the valve body comprising a plurality of external ports, the plurality of external ports comprising a supply port, a first outlet port, a second outlet port and one or more exhaust ports; and
the spool being disposed within the valve body such that:
a) when the spool is in the first position, the supply port and the first outlet port are in fluid communication with each other and the one or more exhaust ports and the second outlet port are in fluid isolation;
b) when the spool is in the second position, the first outlet port and one of the one or more exhaust ports are in fluid communication with each other and the supply port and the second outlet port are in fluid isolation; and
c) when the spool is in the third position, the first outlet port and the second outlet port are in fluid communication with each other and the supply port and the one or more exhaust ports are in fluid isolation.

34. The system of claim 33, wherein:
the one or more exhaust ports numbers two exhaust ports, the two exhaust ports comprising a first exhaust port and a second exhaust port;
the first exhaust port, the supply port, the first outlet port, the second outlet port and the second exhaust port are arranged sequentially between the first hand of the body and the second end of the body; and
when the spool is in the first position, the first outlet port and the supply port are in fluid communication with each other and the second outlet port and the one or more exhaust ports are in respective fluid isolation;
when the spool is in the second position, the first outlet port and the first exhaust port are in fluid communication with each other and the supply port, the second exhaust port, and second outlet port are in respective fluid isolation; and
when the spool is in the third position, the first outlet port and second outlet port are in fluid communication with each other and the supply port and the one or more exhaust ports are in respective fluid isolation.

35. The system of claim 33 wherein:
when the first control valve is in the first position and the second control valve is in the second position, the first chamber is coupled to the fluid supply and the second chamber is coupled to atmosphere;
when the first control valve is in the third position and the second control valve is in the second position, the first chamber is coupled to the fluid reservoir and the second chamber is coupled to atmosphere;
when the first control valve is in the second position and the second control valve is in the second position, the first chamber is coupled to atmosphere and the second chamber is coupled to atmosphere; and
when the first control valve is in the second position and the second control valve is in the third position, the first chamber is coupled to atmosphere and the second chamber s coupled to the fluid reservoir.

36. The system of claim 33 wherein:
when the first control valve is in the second position and the second control valve is in the first position, the first chamber is coupled to atmosphere and the second chamber is coupled to the fluid supply;
when the first control valve is in the second position and the second control valve is in the third position, the first chamber is coupled to atmosphere and the second chamber is coupled to the fluid reservoir;
when the first control valve is in the second position and the second control valve is in the second position, the first chamber is coupled to atmosphere and the second chamber is coupled to atmosphere; and
when the first control valve is in the third position and the second control valve is in the second position, the first chamber is coupled to the fluid reservoir and the second chamber is coupled to atmosphere,

37. The system of claim 35 wherein:
when the first control valve is in the second position and the second control valve is in the first position, the first chamber is coupled to atmosphere and the second chamber is coupled to the fluid supply;
when the first control valve is in the second position and the second valve is in the third position, the first chamber is coupled to atmosphere and the second chamber is coupled to the fluid reservoir;
when the first control valve is in the second position and the second valve is in the second position, the first chamber is coupled to atmosphere and the second chamber is coupled to atmosphere; and
when the first control valve is in the third position and the second valve is in the second position, the first chamber is coupled to the fluid reservoir and the second chamber is coupled to atmosphere.

38. A system comprising:
a first valve and a second valve, the first and second valve each including a spool within a valve body and movable within the valve body from a first position, a second position, and a third position, the third position being physically located between the first position and the second position;
a double-acting pneumatic actuator pneumatically coupled to the first valve and the second valve;
a fluid supply pneumatically coupled to the first valve and the second valve;
a fluid reservoir pneumatically coupled to the first valve and second valve;
the double-acting pneumatic actuator comprising a first chamber and a second chamber; and
when the spool of the first valve is in the first position and the spool of the second valve is in the second position, the first chamber is coupled to the fluid supply and the second chamber is coupled to atmosphere;
when the spool of the first valve is in the third position and the spool of the second valve is in the second position, the first chamber is coupled to the fluid reservoir and the second chamber is coupled to atmosphere;
when the spool of the first valve is in the second position and the spool of the second valve is in the second position, the first chamber is coupled to atmosphere and the second chamber is coupled to atmosphere; and
when the spool of the first valve is in the second position and the spool of the second valve is in the third position, the first chamber is coupled to atmosphere and the second chamber is coupled to the fluid reservoir.

39. The system of claim 38 wherein:
when the spool of the first valve is in the second position and the spool of the second valve is in the first position, the first chamber is coupled to atmosphere and the second chamber is coupled to the fluid supply;
when the spool of the first valve is in the second position and the spool of the second valve is in the third position, the first chamber is coupled to atmosphere and the second chamber is coupled to the fluid reservoir;
when the spool of the first valve is in the second position and the spool of the second valve is in the second position, the first chamber is coupled to atmosphere and the second chamber is coupled to atmosphere; and
when the spool of the first valve is in the third position and the spool of the second valve is in the second position, the first chamber is coupled to the fluid reservoir and the second chamber is coupled to atmosphere.

40. The system of claim 39 wherein:
the valve body of each of the first and second valves comprises:
a supply port, a first outlet port, a second outlet port and one or more exhaust ports wherein:
a) when the spool is in the first position, the supply port and the first outlet port are in fluid communication with each other and the one or more exhaust ports and second outlet port are in fluid isolation;
b) when the spool is in the second position, the first outlet port and one of the one or more exhaust ports are in fluid communication with each other and the supply port and the second outlet port are in fluid isolation; and
c) when the spool is in the third position, the first outlet port and the second outlet port are in fluid communication with each other and the supply port and the one or more exhaust ports are in fluid isolation.

41. The system of claim 40 wherein:
the one or more exhaust ports number two exhaust ports, the two exhaust ports comprising a first exhaust port and a second exhaust port; and
the first exhaust port, the supply port, the first outlet port, the second outlet port and the second exhaust port are arranged sequentially between the first end of the body and the second end of the body; and
when the spool is in the first position, the first outlet port and the supply port are in fluid communication with each other and the second outlet port and the one or more exhaust ports are in respective fluid isolation;
when the spool is in the second position, the first outlet port and the first exhaust port are in fluid communication with each other and the supply port, the second exhaust port, and second outlet port are in respective fluid isolation; and
when the valve spool is in the third position, the first outlet port and second outlet port are in fluid communication with each other and the supply port and the one or more exhaust ports are in respective fluid isolation.

42. A method of charging and discharging a pneumatic pressure vessel, the method comprising:
A. providing the valve of claim 2;
B. fluidly connecting the valve to a fluid supply, a reservoir and the pressure vessel;
C. configuring the spool into the first position and thereby causing fluid to flow from the fluid supply into the pressure vessel;
D. configuring the spool into the third position and thereby causing the flow of fluid from the pressure vessel into the reservoir;
E. maintaining the spool in the third position until such time as the pressures in the pressure vessel and reservoir arrive at a common equilibrium pressure;
F. configuring the spool into the second position and thereby causing the flow of fluid from the pressure vessel to atmosphere;
G. configuring the spool into the third position and thereby causing the flow of fluid from the reservoir to the pressure vessel;
H. maintaining the spool in the third position until such time as the pressures in the pressure vessel and reservoir arrive at a common equilibrium pressure; and
I configuring the spool into the first position and thereby causing the flow of fluid from the fluid supply into the pressure vessel.

43. The method of claim 42 wherein the pressure vessel is the fluid chamber of a single-acting actuator and:
the single-acting actuator is placed in a first actuator position when the valve is configured in accordance with paragraph C and a second actuator position when the valve is configured in accordance with paragraph F.

44. A method of charging and discharging a pneumatic pressure vessel, the method comprising:
A. providing the valve of claim 3;
B. fluidly connecting the valve to a fluid supply, a reservoir and the pressure vessel;
C. configuring the spool into the first position and thereby causing the flow of fluid from the fluid supply into the pressure vessel;
D. configuring the spool into the third position and thereby causing the flow of fluid from the pressure vessel into the reservoir,
E. maintaining the spool in the third position until such time as the pressures in the pressure vessel and reservoir arrive at a common equilibrium pressure;
F. configuring the spool into the second position and thereby causing the flow of fluid from the pressure vessel to atmosphere;
G. configuring the spool into the third position and thereby causing the flow of fluid from the reservoir to the pressure vessel;
H. maintaining the spool in the third position until such time as the pressures in the pressure vessel and reservoir arrive at a common equilibrium pressure; and
I. configuring the spool into the first position and thereby causing the flow of fluid from the fluid supply into the pressure vessel.

45. The method of claim 44 wherein the pressure vessel is the fluid chamber of a single-acting actuator and:
the single-acting actuator is placed in a first actuator position when the valve is configured in accordance with paragraph C and a second actuator position when the valve is configured in accordance with paragraph F.

46. A method for pneumatically actuating a double-acting actuator having a first chamber and a second chamber, the method comprising:
providing two valves, a first valve and a second valve, according to claim 2;
fluidly connecting: the supply ports of the first and second valves to a fluid supply; the one or more exhaust ports of the first and second valves to exhaust; the first outlet port of the first valve to the first chamber; the first outlet port of the second valve to the second chamber;
the second outlet port of the first valve to the reservoir; and the second outlet port of the second valve to the reservoir;
C. configuring the spool of the first valve into the first position and the spool of the second valve into the second position thereby causing the flow of fluid from the fluid supply into the first chamber;
D. maintaining the spool of the second valve in the second position and configuring the spool of the first valve into the third position and thereby causing the flow of fluid from the first chamber into the reservoir;
E. maintaining the spools of the first and second valves in the configurations of step D until such time as the pressures in the first chamber and reservoir arrive at a common equilibrium pressure;
F. maintaining the spool of the second valve in the second position and configuring the spool of the first valve into the second position and thereby causing the flow of fluid from the first chamber to atmosphere;
G. maintaining the spool of the first valve in the second position and configuring the spool of the second valve into the third position and thereby causing the flow of fluid from the reservoir to the second chamber;
H. maintaining the spools of the first valve and second valve in the configurations of step G until such time as the pressures in the second chamber and reservoir arrive at a common equilibrium pressure;
I. maintaining the spool of the first valve in the second position and configuring the spool of the second valve into the first position and thereby causing the flow of fluid from the fluid supply into the second chamber;
J. maintaining the spool of the first valve in the second position and configuring the spool of the second valve into the third position and thereby causing the flow of fluid from the second chamber into the reservoir;
K. maintaining the spools of the first valve and second valve in the configurations of step J until such time as the pressures in the second chamber and reservoir arrive at a common equilibrium pressure;
L. maintaining the spool of the first valve in the second position and configuring the second valve into the second position and thereby causing the flow of fluid from the second chamber to exhaust;
M. maintaining the spool of the second valve in the second position and configuring the spool of the first valve into the third position and thereby causing the flow of fluid from the reservoir into the first chamber; and
N. maintaining the spool of the second valve in the second position and configuring the spool of the first valve into the first position and thereby causing the flow of fluid from the fluid supply into the first chamber.

47. A method for pneumatically actuating a double-acting actuator having a first chamber and a second chamber, the method comprising:
providing two valves, a first valve and a second valve, according to claim 3;
fluidly connecting: the supply ports of the first and second valves to a fluid supply; the one or more exhaust ports of the first and second valves to exhaust; the first outlet port of the first valve to the first chamber; the first outlet port of the second valve to the second chamber; the second outlet port of the first valve to the reservoir; and the second outlet port of the second valve to the reservoir;
C. configuring the spool of the first valve into the first position and the spool of the second valve into the second position thereby causing the flow of fluid from the fluid supply into the first chamber;
D. maintaining the spool of the second valve in the second position and configuring the spool of the first valve into the third position and thereby causing the flow of fluid from the first chamber into the reservoir;
E. maintaining the spools of the first and second valves in the configurations of step D until such time as the pressures in the first chamber and reservoir arrive at a common equilibrium pressure;
F. maintaining the spool of the second valve in the second position and configuring the spool of the first valve into the second position and thereby causing the flow of fluid from the first chamber to atmosphere;
G. maintaining the spool of the first valve in the second position and configuring the spool of the second valve into the third position and thereby causing the flow of fluid from the reservoir to the second chamber;
H. maintaining the spools of the first valve and second valve in the configurations of step G until such time as the pressures in the second chamber and reservoir arrive at a common equilibrium pressure;
I. maintaining the spool of the first valve in the second position and configuring the spool of the second valve into the first position and thereby causing the flow of fluid from the fluid supply into the second chamber;
J. maintaining the spool of the first valve in the second position and configuring the spool of the second valve into the third position and thereby causing the flow of fluid from the second chamber into the reservoir;
K. maintaining the spools of the first valve and second valve in the configurations of step J until such time as the pressures in the second chamber and reservoir arrive at a common equilibrium pressure;
L. maintaining the spool of the first valve in the second position and configuring the second valve into the second position and thereby causing the flow of fluid from the second chamber to exhaust;
M. maintaining the spool of the second valve in the second position and configuring the spool of the first valve into the third position and thereby causing the flow of fluid from the reservoir into the first chamber; and
N. maintaining the spool of the second valve in the second position and configuring the spool of the first valve into the first position and thereby causing the flow of fluid from the fluid supply into the first chamber.
